(19) United States
(12) Patent Application Publication
(10) Pub. No.: US 2005/0025364 A1
(43) Pub. Date: Feb. 3, 2005

(54) Apparatus and method for reading a user's palm using mobile terminal

(76) Inventors: Soon-Jin Kim, Gumi-si (KR); Yong-Dae Baek, Dong-gu (KR); Yong-Su Kim, Gunpo-si (KR); Si-Hwan Kim, Seoul (KR); Hee-Jae Kim, Daiseo-gu (KR); Jea-Wook Choi, Dalsaong-gun (KR); Young-Seok Kim, Gimhao-si (KR); Kyung-Youn Lee, Suseong-gu (KR); Eun-Ha Yoon, Yeongdeok-gun (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/901,221

(22) Filed: Jul. 29, 2004

(30) Foreign Application Priority Data
Jul. 30, 2003 (KR) 2003-52821

(51) Int. Cl. G06K 9/00

(52) U.S. Cl. 382/190

(57) ABSTRACT

An apparatus and method for reading a user's palm using a mobile terminal by extracting a life line, a heart line and a head line from the user's palm. The apparatus and method comprise photographing the user's palm when the mobile terminal is in a palm photograph mode and converting the photographed palm image to a grayscale image. The apparatus and method further comprise detecting edges in the palm image, extracting a value of each line of the palm, obtaining a length and a slope of each line of the palm based on the extracted value, and outputting results of the palm reading based on the length and slope of each line of the palm.

### PRIORITY

This application claims to the benefit under 35 U.S.C. § 119(a) of an application entitled “Method for Reading Palm Using Mobile Terminal” filed with the Korean Intellectual Property Office on Jul. 30, 2003 and assigned Serial No. 2003-52821, the entire contents of which are incorporated herein by reference.

### BACKGROUND OF THE INVENTION

1. Field of the Invention

The present invention relates to an apparatus and method for reading a palm. More particularly, the present invention relates to an apparatus and method for reading a user's palm using a mobile terminal.

2. Description of the Related Art

Many people believe that the lines of an individual's palm reveal how things may occur or change in their future and destiny. Some of the lines are not permanent and may change based on the individual's efforts or due to a change in the individual's health, a change in environment or a change in the fortune of the individual.

Although the positions of major lines, such as the life line, head line and heart line, are permanent, fine lines connected to the major lines or other minor lines may disappear or appear over time on an individual's palm. The lines of the palm may also create a new shape or mark which many people believe predicts a change in fortune. Such changes in the palm lines do not periodically occur over time or at regular intervals. A new line may appear to tell a personal crisis in the near future. Palm readers believe that unless there is or will be a sudden change in fortune, the lines of the palm will remain unchanged for a long time. How often the palm lines are changed is unique to each individual and varies depending on occupation. Palm readers suggest that people engaged in a business that has fluctuations between profits and losses generally experience more frequent changes in their palm lines than salaried people. Palm readers suggest that they can predict any change in their fortunes by carefully observing palm lines that have recently appeared or disappeared. Since palm reading is believed to give an insight into one's character, fortune or future, it has been shrouded in mystery.

Generally, a person who wishes to interpret their palm lines visits a palm reader or tries palm reading using a palmistry-related book or information obtained through the Internet. If a mobile terminal offers a palm reading function, it will be an entertaining pastime to amuse a user with palm reading regardless of the time or place.

### SUMMARY OF THE INVENTION

Accordingly, an object of the present invention is to provide a method for reading a palm using a mobile terminal.

In order to accomplish the object of the present invention, an apparatus and method for reading a palm using a mobile terminal are provided, The apparatus and method comprise photographing a palm in a palm photograph mode; converting the photographed palm image to a grayscale image; detecting edges in the palm image; extracting a value of each line of the palm; obtaining a length and a slope of each line of the palm based on the extracted value; and outputting results of a palm reading based on the length and slope of each line of the palm.

In order to accomplish another object of the present invention, an apparatus and method for reading a palm using a mobile terminal are provided. The apparatus and method comprise displaying a hand shape frame when the mobile terminal is changed to a palm photograph mode; photographing a palm within the hand shape frame; converting the photographed palm image to a grayscale image; detecting edges in the palm image; measuring a length and a slope of a life line of the palm; measuring a length of a heart line of the palm; measuring a length and a slope of a head line of the palm; and outputting results of a palm reading based on the measured lengths and slopes of the lines of the palm.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a mobile terminal having a palm reading function according to an embodiment of the present invention;

FIG. 2A is a flow chart illustrating a process of reading a palm using a mobile terminal according to an embodiment of the present invention;

FIG. 2B is a diagram illustrating an original image taken in the palm photograph mode of FIG. 2A;

FIG. 3A is a flow chart illustrating a process of converting an original image to a grayscale image in the palm reading process of FIG. 2A;

FIG. 3B illustrates an image processed according to the process of FIG. 3A;

FIG. 4A is a flow chart illustrating a process for showing the contrast enhancement in the palm reading process of FIG. 2A;

FIG. 4B is a diagram illustrating an image processed according to the process of FIG. 4A;

FIG. 5A is a flow chart illustrating a process for performing edge detection in the palm image in the palm reading process of FIG. 2A;

FIGS. 5B and 5C are diagrams illustrating the process of FIG. 5A;

FIG. 5D is a diagram illustrating an image obtained when a 3×3 mask is applied;

FIG. 5E is a diagram illustrating an image obtained when a 5×5 mask is applied;

FIG. 5F is a diagram illustrating an image processed according to FIG. 5A;

FIG. 6A is a flow chart illustrating a process for the removal of image noise, such as fine lines, in the palm reading process of FIG. 2A;

FIGS. 6B and 6C are diagrams illustrating the process of FIG. 6A;

FIG. 6D is a diagram illustrating an image before the process of FIG. 6A is performed;

FIG. 6E is a diagram illustrating an image processed according to the process of FIG. 6A;

FIG. 7A is a flow chart illustrating a process for the binarization in the palm reading process of FIG. 2A;

FIG. 7B is a diagram illustrating an image processed according to the process of FIG. 7A;

FIG. 8A is a flow chart illustrating a process for the shape manipulation in the palm reading process of FIG. 2A;

FIG. 8B is a diagram illustrating the mask in FIG. 8A;

FIG. 8C is a diagram illustrating an image processed according to the process of FIG. 8A;

FIG. 9 is a flow chart illustrating a process for the extraction of the lines on the palm in the palm reading process of FIG. 2A;

FIG. 10A is a flow chart illustrating a process showing the extraction of a value of the life line in FIG. 9 according to an embodiment of the present invention;

FIGS. 10B and 10C are views for explaining the process of FIG. 10A;

FIG. 10D is a diagram illustrating a movement for extracting the life line in FIG. 10A;

FIG. 10E is a diagram illustrating an image of the life line extracted according to the process of FIG. 10A;

FIGS. 10F and 10G are flow charts showing the extraction of a value of the life line in FIG. 9 according to an embodiment of the present invention;

FIGS. 10H through 10K are diagrams illustrating each process of FIGS. 10F and 10G;

FIG. 10L is a diagram illustrating a movement for extracting the life line in FIGS. 10F and 10G;

FIG. 10M is a diagram illustrating an image of the life line extracted according to the processes of FIGS. 10F and 10G;

FIG. 11A is a flow chart illustrating a process for the extraction of a value of the heart line in FIG. 9 according to an embodiment of the present invention;

FIG. 11B is a flow chart illustrating a process of extracting a value of the heart line in FIG. 9 according to an embodiment of the present invention;

FIG. 11C is a diagram illustrating the heart line in the original image of the palm;

FIGS. 11D and 11Ee are diagrams illustrating the heart line extracted according to an embodiment of the present invention;

FIGS. 11F and 11G are diagrams illustrating the heart line extracted according to an embodiment of the present invention;

FIG. 11H is a diagram illustrating a movement for extracting the heart line in the processes of FIGS. 11A and 11B;

FIG. 11I is a diagram illustrating an image of the heart line extracted according to the processes of FIGS. 11A and 11B;

FIGS. 12A and 12B are flow charts showing the extraction of a value of the head line in FIG. 9;

FIGS. 12C and 12D are diagrams illustrating the head line extracted according to the processes of FIGS. 12A and 12B;

FIG. 12E is a diagram illustrating a movement for extracting the value of the head line in the processes of FIGS. 12A and 12B;

FIG. 12F is a diagram illustrating an image of the head line extracted according to the process of FIG. 12A;

FIG. 13A is a flow chart illustrating a process for the interpolation of the palm lines in the palm reading process of FIG. 2A;

FIG. 13B is a diagram illustrating a structure of a stack for storing the values of the palm lines in FIG. 9;

FIG. 13C is a diagram illustrating an image of the life line obtained according to the process of FIG. 13A;

FIG. 13D is a diagram illustrating an image of the heart line obtained according to the process of FIG. 13A; and

FIG. 13Ee shows an image of the head line obtained according to the process of FIG. 13A.

In the drawings, it should be understood that the same reference numerals are used throughout the drawings.

### DETAILED DESCRIPTION OF THE PREFERRED EMBODIMENTS

Hereinafter, embodiments of the present invention will be described with reference to the accompanying drawings.

An exemplary hand shape frame, areas in which the life line, heart line and head line begin on a palm, a mask type, and so on, are used in the following description. However, it should be obvious to those skilled in the art that such exemplary descriptions and definitions are merely provided to improve understanding of the present invention and that the present invention can be performed with various modifications.

In the following description of the embodiments of the invention, a mobile terminal equipped with a camera will be explained. However, the present invention is equally applicable to general mobile terminals without cameras. Also, either a left hand or a right hand can be photographed for the purpose of palm reading according to an embodiment of the present invention. It is assumed that an image photographed in embodiments of the present invention has a size of 352×288 pixels. The “palm reading function” provided in embodiments of the present invention refers to a function of interpreting the life line, heart line and head line on a user's palm and informing the user of their fortunes, such as marriage prospects, occupation, personality and state of health.

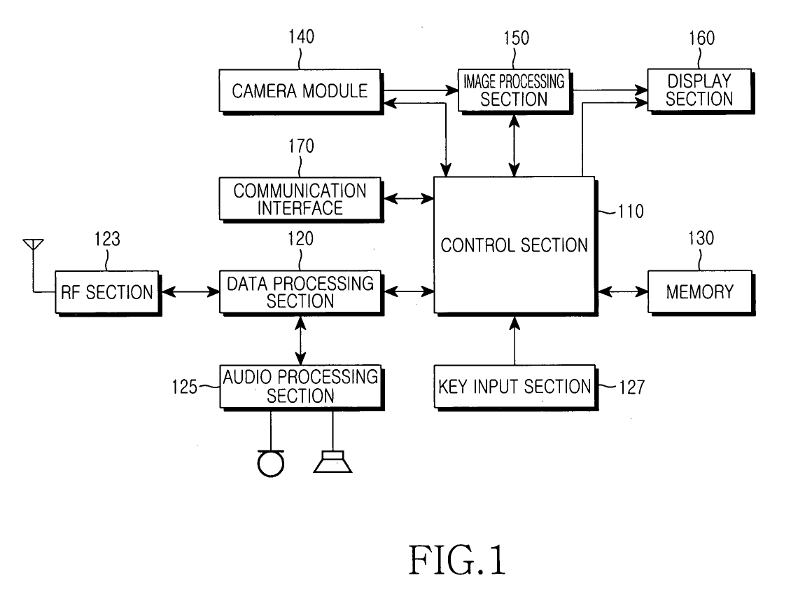

FIG. 1 is a block diagram illustrating a mobile terminal according to an embodiment of the present invention.

Referring to FIG. 1, a Radio Frequency (RF) section 123 performs a wireless communication function. The RF section 123 comprises a RF transmitter (not shown) for performing upward conversion and amplification of the frequency of a signal, which is being transmitted, and an RF receiver (not shown) for amplifying a signal, which is being received, with low noise and performing downward conversion of the frequency of the signal. A data processing section 120 comprises a transmitter (not shown) for coding and modulating a signal which is being transmitted and a receiver (not shown) for demodulating and decoding a signal which is being received. The data processing section 120 may comprise a modem and a codec. The codec comprises a data codec for processing packet data and an audio codec for processing an audio signal such as a speech signal. An audio processing section 125 reproduces an audio signal output from the audio codec of the data processing section 120 or transmits an audio signal generated from a microphone to the audio codec of the data processing section 120.

A key input section 127 is provided with keys for inputting numbers and characters and function keys for setting up various functions. The key input section 127 also includes keys for implementing the palm reading function according to embodiments of the present invention.

A memory 130 may comprise a program memory, a data memory and an image memory for storing images of palm lines according to embodiments of the present invention. The program memory includes programs for controlling general operations of the mobile terminal and those for processing a palm image output to a display section 160 according to embodiments of the present invention. The data memory temporarily stores data generated during implementation of the above programs. Also, the image memory stores image data of the palm.

A control section 110 controls the overall operations of the mobile terminal. The control section 110 may include the data processing section 120. The control section 110 controls operations for implementing the palm reading function according to a mode set by a command input through the key input section 127.

A camera module 140 is used to form image data. The camera module 140 comprises a camera sensor for converting a photographed optical signal into an electrical signal and a signal processor for converting an analog image signal photographed by the camera sensor into digital data. Assuming that the camera sensor is a charge coupled device (CCD) sensor, the signal processor can be a digital signal processor (DSP). The camera sensor and the signal processor can be either integrated into a single element or separated as independent elements.

An image processing section 150 generates picture data for displaying an image signal output from the camera module 140. The image processing section 150 processes image signals output from the camera module 140 in frames. Also, the image processing section 150 adjusts the frame image data to conform to the features, such as size and resolution, which are displayable on the display unit 160, and outputs the adjusted frame image data. The image processing section 150 comprises an image codec, and compresses the frame image data displayed on the display unit 160 in a preset manner or restores the compressed frame image data to the original frame image data.

The display unit 160 displays image data output from the image processing section 150 or user data output from the control section 110. Also, the display unit 160 displays a moving picture reproduced under the control of the control section 110. The display unit 160 can be a Liquid Crystal Display (LCD) comprising an LCD controller, a memory for storing image data and an LCD device. When the LCD is a touch screen, it can serve as an input section.

A communication interface 170, which is connected to an external communication device, controls transmission and receiving of photographed image data to and from the external device. The external device can be a scanner, a computer, a digital camera or the like. The communication interface 170 performs communication interface between the mobile terminal and the external device under the control of the control section 110. The communication interface 170 outputs stored image data or receives image data from the external device.

Referring to FIG. 1, the mobile terminal according to an embodiment of the present invention can photograph a palm to display or transmit the photographed palm image. The camera module 140 is built into the mobile terminal or connected to an outer side of the mobile terminal. In other words, the camera module 140 can be either an internal or an external element of the mobile terminal. The camera module 140 can use a charge coupled device (CCD) sensor. The CCD sensor converts an image photographed by the camera module 140 into an electrical signal which is then converted into digital image data by the signal processor within the camera module 140. The digital image data and synchronization signals are output to the image processing section 150. The synchronization signals can be Horizontal Synchronization signals (Hsync) or Vertical Synchronization signals (Vsync).

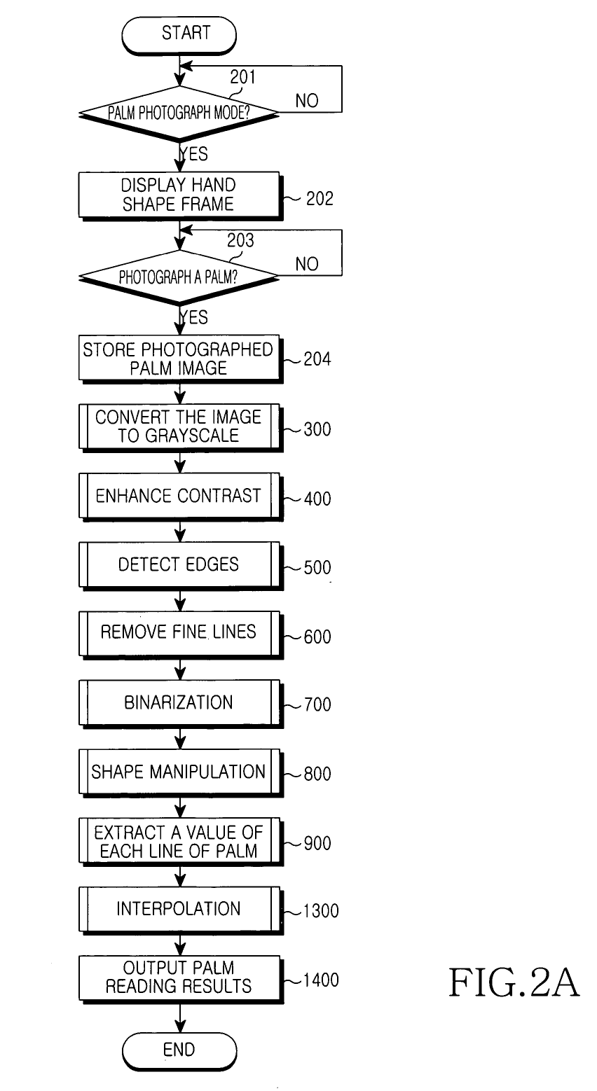

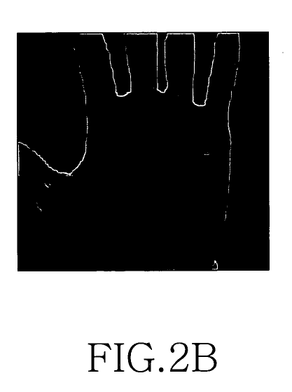

FIG. 2A is a flow chart illustrating a process of reading a palm using a mobile terminal according to an embodiment of the present invention.

The embodiments of the present invention will now be described in detail with reference to FIGS. 1 and 2A.

Referring to FIG. 2A, the user can select a “palm” menu using the key input section 127 while the mobile terminal is in a menu display mode. The control section 110 detects the selection of the “palm” menu and displays items contained in that menu. If the user selects “display a palm” from the displayed items, the control section 110 will detect the selection and will display stored image data for a palm on the display section 160. If the user selects “palms of celebrities” from the displayed items, the control section 110 will detect the selection and will display image data of celebrity palms on the display section 160. If the user selects “photograph a palm,” the control section 110 will detect the selection at step 201 and will change the current mode of the mobile terminal to a palm photograph mode. In the palm photograph mode, the control section 110 controls the display section 160 to display a hand shape frame at step 202. The displayed hand shape frame includes areas in which the life line, heart line and head line begin on the palm. If the user presses a camera key with one hand placed on the hand shape frame displayed at step 202, the control section 110 will detect the key input at step 203 and will store the photographed palm image at step 204. FIG. 2B shows an exemplary photographed palm image.

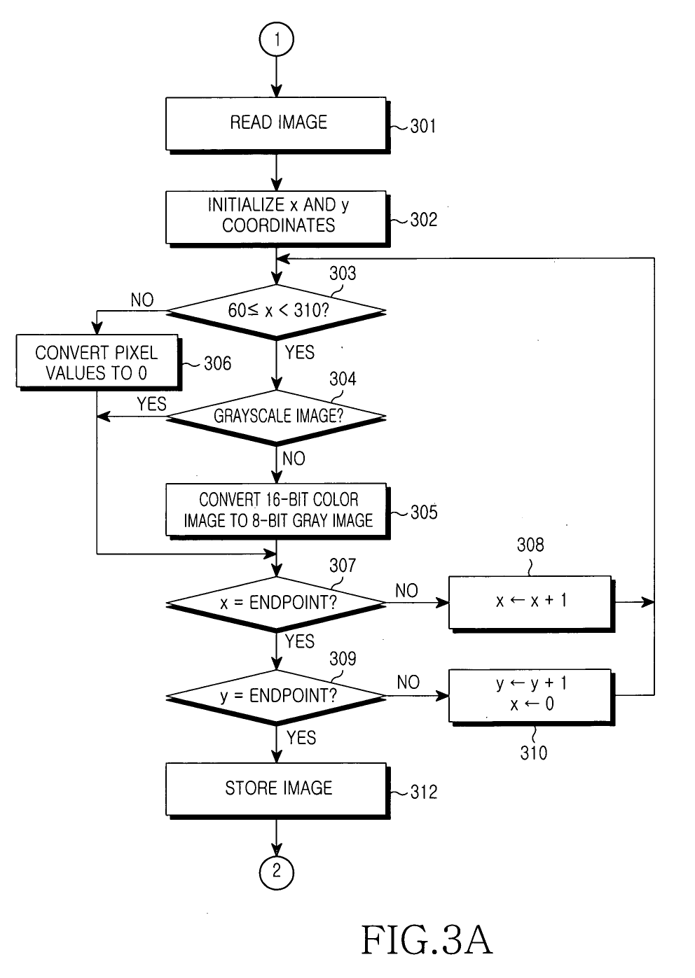

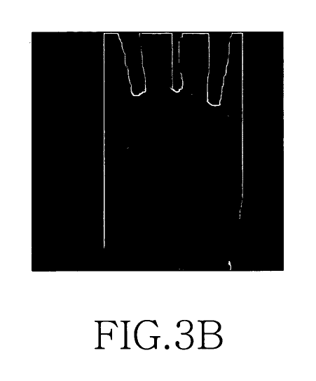

The photographed palm image is converted to a grayscale image at step 300. FIG. 3A is a flow chart illustrating a process of converting the original palm image to a grayscale image. Assuming that the photographed image is 352×288 pixels in size, “60≦×310” in FIG. 3A is an area of the image data that can be converted to grayscale. The rest of the image data is to be eliminated.

Referring to FIG. 3A, the control section 110 reads the stored image data at step 301 and proceeds to step 302 to initialize X and Y coordinates in the above image data area. Subsequently, the control section 110 scans the whole area (352×288 pixels) of the image data and determines whether the X coordinate on a particular position of the image data in pixels is in the range of 60≦×310 at step 303. The control section 110 also determines whether the image data included in that range is colored. If the image data is colored, the control section 110 will detect this at step 304 and will convert the 16-bit color image to a 8-bit grayscale image at step 305. As is known in the art, Luminance In-phase Quadrature (YIQ) is a color space that separates luminance from a Red, Green, Blue (RGB) color space. It is possible to obtain a desired grayscale image by converting RGB to YIQ.
Y=0.299R+0.587G+0.114B
I=0.596R−0.275G−0.321B
Q=0.212R−0.523G+0.311B
Gray=R×0.299+G×0.587+B×0.114 Formula 1

Formula 1 is an algorithm for converting a RGB color space to a YIQ grayscale space. The Y component of YIQ is luminance, while the I and Q components are actual color information. Accordingly, grayscale information can be obtained when the Y value is only applied to RGB.

If the X coordinate on a particular position of the image data is not included in the range of 60≦×<310, the control section 110 will detect this at step 303 and will proceed to step 306 to convert the pixel values of the image data which are not included in that range to “0.”

While performing steps 303 through 306, the control section 110 determines whether an X coordinate corresponds to a horizontal endpoint of the image data. If the X coordinate is not a horizontal endpoint of the image data, the control section 110 will detect this at step 307 and will proceed to step 308 to increase the X variable by one. The control section 110 will then repeat steps 303 through 306. If the X coordinate is a horizontal endpoint of the image data, the control section 110 will detect this at step 307 and will determine whether the Y coordinate on the same position is a vertical endpoint of the image data. If the Y coordinate is not a vertical endpoint of the image data, the control section 110 will detect this at step 309 and will proceed to step 310 to increase the Y variable by one and initialize the X variable. The control section 110 will then repeat steps 303 through 306 again. If the Y coordinate is a vertical endpoint of the image data, the control section will detect this at step 309 and will proceed to step 312. The grayscale image converted from a color image at step 305 and the image with pixel values converted to “0” at step 306 are stored in the memory 130. FIG. 3B shows the palm image converted to grayscale at steps 303 to 305.

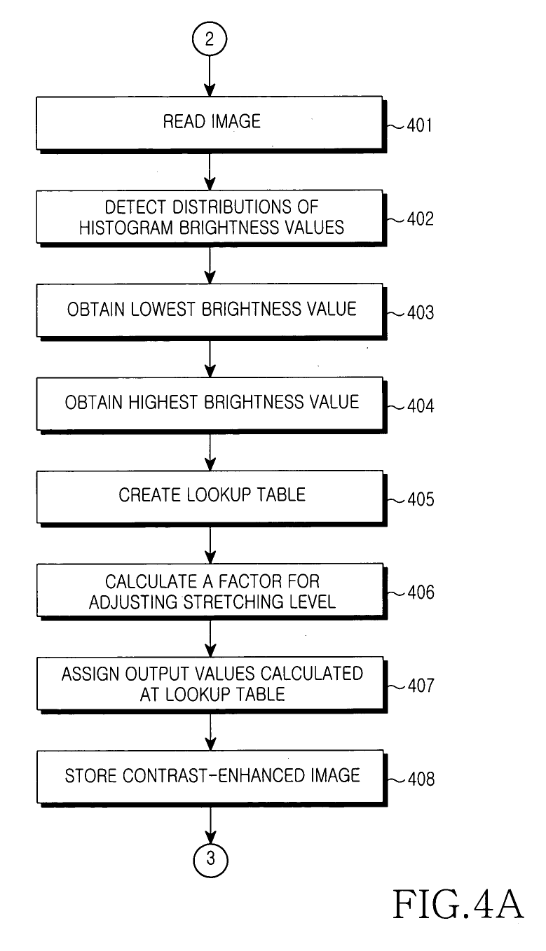

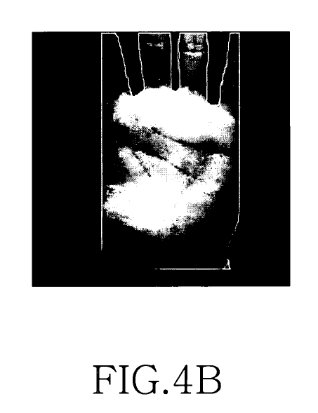

At step 400, the image data converted to grayscale is processed to have enhanced contrast. FIG. 4A is a flow chart illustrating a process of enhancing the contrast in the grayscale image. In an embodiment of the present invention, a histogram stretching algorithm is used to enhance the image contrast.

Referring to FIG. 4A, at step 401, the control section 110 reads the palm image stored at step 304. The control section 110 detects the distributions of varying brightness values over the palm image at step 402. The control section 110 obtains the lowest brightness value and the highest brightness value at steps 403 and 404, respectively. After creating a lookup table based on the lowest and highest brightness values at step 405, the control section 110 proceeds with step 406 to calculate a new pixel value that can adjust the contrast stretching level. The new pixel value can be obtained using Formula 2.

$$New pixel value = \frac{\begin{matrix}previous pixel value - \\ lowest brightness value\end{matrix}}{\begin{matrix}highest brightness value - \\ lowest birghtness value\end{matrix}} \times 255 \qquad Formula 2$$

The control section 110 assigns output values calculated at the lookup table to the palm image data at step 407, which makes dark colors in the image data darker and bright colors brighter, thereby enhancing the image contrast. The control section 110 stores the contrast-enhanced palm image at step 408. FIG. 4B shows the palm image with contrast enhanced via histogram stretching.

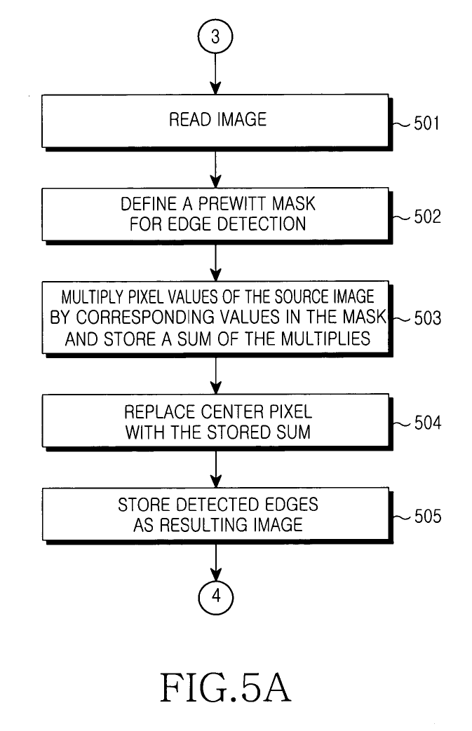

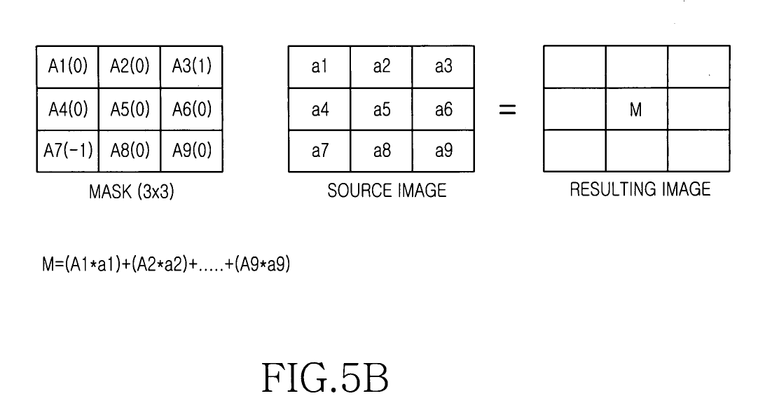

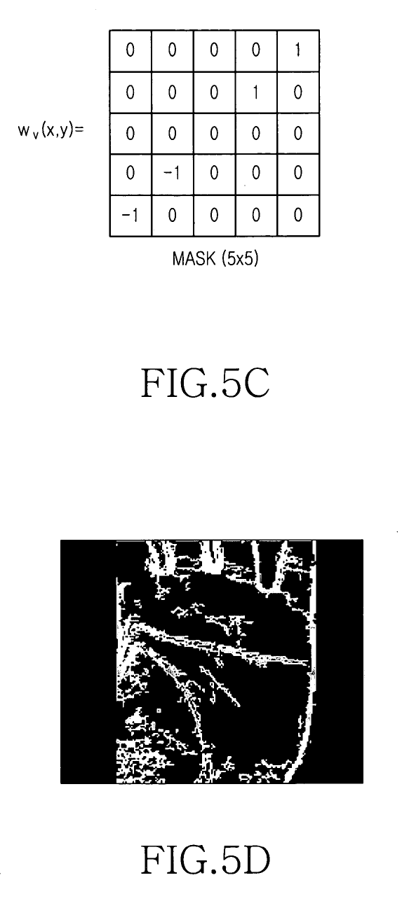

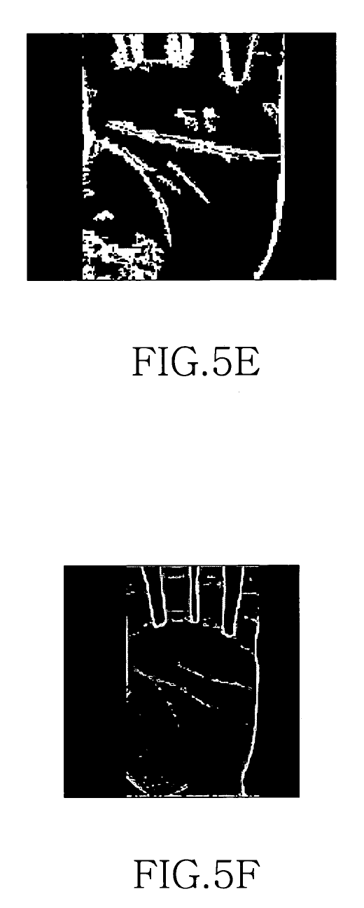

At step 500, edge detection is performed on the contrast-enhanced palm image. FIG. 5A is a flow chart illustrating a process of detecting edges in the palm image. In an embodiment of the present invention, Prewitt masks are used to detect the edges in the palm image. Referring to FIG. 5A, the control section 110 reads the palm image stored in the memory 130 at step 501 and proceeds to step 502 to define a Prewitt mask for edge detection. FIGS. 5B and 5C show a 3×3 mask and a 5×5 mask, respectively, which are used to detect the edges. When the 3×3 mask as shown in FIG. 5B is applied to the source image, the control section 110 multiplies the 3×3 array of pixel values of the source image (eight pixels surrounding the center pixel) by the corresponding values in the mask and sums the product into a single result M which is stored in the memory 130 at step 503. Subsequently, the control section 110 replaces the center pixel value a5 with the stored result M at step 504. The resulting palm image is stored in the memory 130 at step 505. FIG. 5F shows the palm image with edges detected using a Prewitt mask and stored at step 505. FIG. 5E shows an image obtained when a 5×5 mask is applied. As is clear from FIGS. 5D and 5E, the 5×5 mask can reduce image noise to a greater extent than the 3×3 mask can in edge detection. Therefore, the 5×5 mask is preferred in detecting the edges in the palm image.

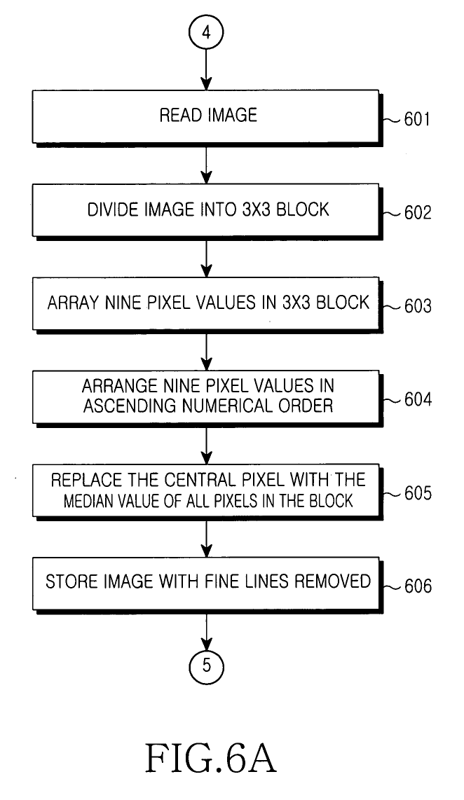

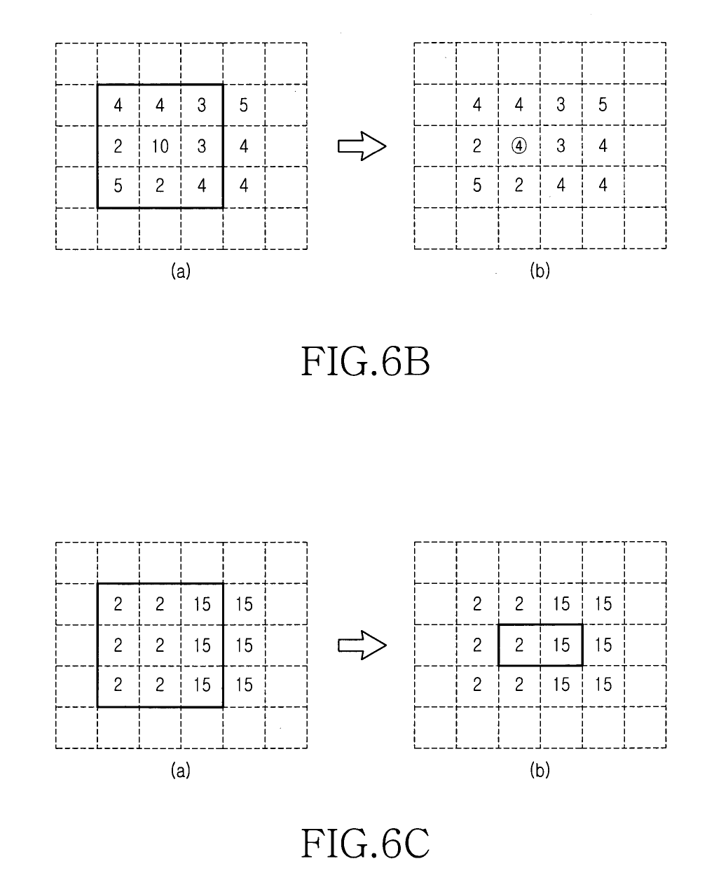

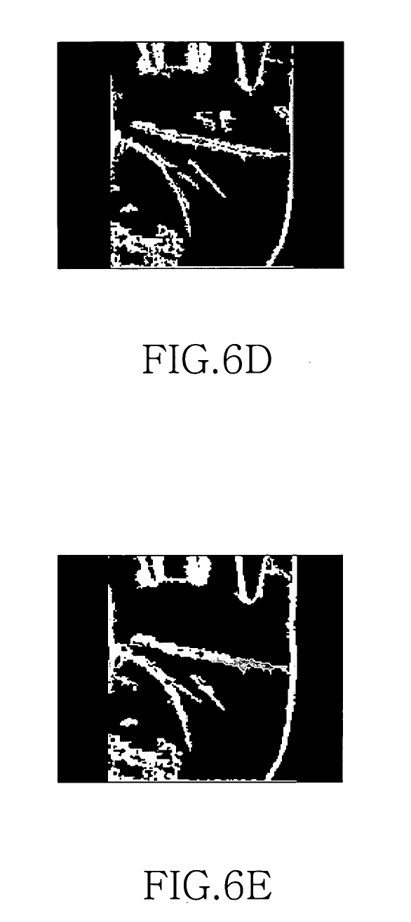

After edge detection using a Prewitt mask at step 500, the control section 110 performs filtering at step 600 to enhance the image and reduce noise by removing fine lines on the palm image. In an embodiment of the present invention, median filtering is performed to reduce noise in an image. FIG. 6a is a flow chart illustrating a process of performing median filtering on the palm image. Referring to FIG. 6A, the control section 110 reads the palm image stored in the memory 130 at step 601 and proceeds to step 602 to divide the image into nine pixels in a 3×3 block. After considering the values in the nine pixels in turn at step 603, the control section 110 arranges the pixel values in ascending numerical order at step 604 and replaces the value of the central pixel (fifth pixel in the 3×3 block) with the median value of all pixels in the block at step 605. FIGS. 6B and 6C show examples of median filtering. To be specific, FIG. 6B (a) shows nine pixels in a 3×3 block. The values in the nine pixels are arrayed in the ascending order of “2, 2, 2, 2, 4, 4, 4, 5, 10.” As shown in FIG. 6B (b), the value of the centeral pixel in the 3×3 block is replaced with the median “4” of the arranged pixel values. In this median filtering, the pixel value “10” which is the noise component is removed. FIG. 6C (a) shows nine pixels in a 3×3 block. The values in the nine pixels are arrayed in the ascending order of “2, 2, 2, 2, 2, 2, 15, 15, 15.” As shown in FIG. 6C (b), the value of the centeral pixel in the 3×3 block is replaced with the median “2” of the arranged pixel values. FIGS. 6B(a) and 6C(a) show pixels with edges. As is clear from FIGS. 6B(b) and 6C(b), the median filter response completely preserves edges. The palm image enhanced by median filtering is stored in the memory 130 at step 606. FIG. 6D shows the palm image before the application of a median filter. FIG. 6E shows the palm image enhanced by the application of a median filter.

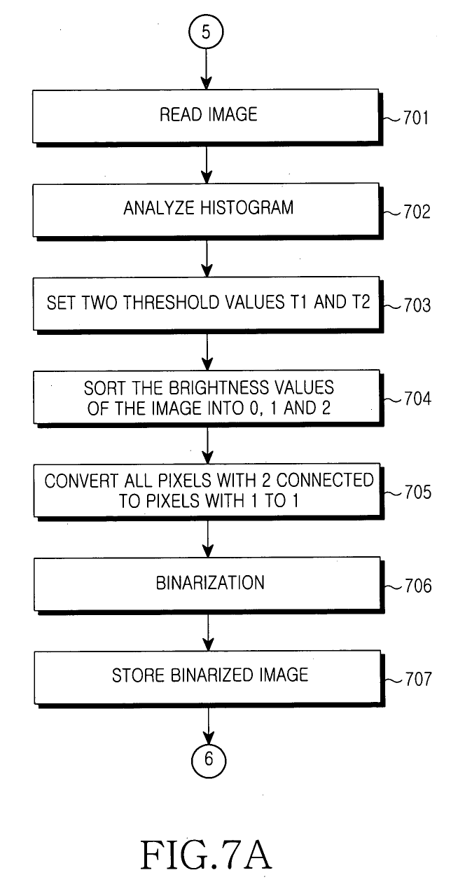

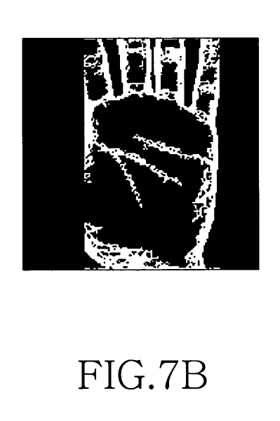

In order to remove image noise and improve pixel connectivity, the control section 110 performs binarization at step 700. In an embodiment of the present invention, binary thresholding is performed to make sharp edges in the palm image sharper and weak edges weaker. The binary thresholding process removes noise and fine lines in the palm image using two threshold values. FIG. 7A is a flow chart illustrating a process of performing binary thresholding on the palm image. Referring to FIG. 7A, the control section 110 reads the palm image at step 701 and analyzes the histogram used at step 400 to extract the brightness values of the palm image at step 702. The control section 110 sets two threshold values T1 and T2 at step 703 and proceeds to step 704 to sort the brightness values of the palm image into 0, 1(T1) and 2(T2). After changing pixels of “2” which are connected to pixels of “1” to have the value “1” at step 705, the controls section 110 converts the 256 grayscale image to a binary image with pixel values of only 0 and 1 at step 706. The binarized palm image is stored in the memory 130 at step 707. FIG. 7B shows the palm image binarized into zeros and ones.

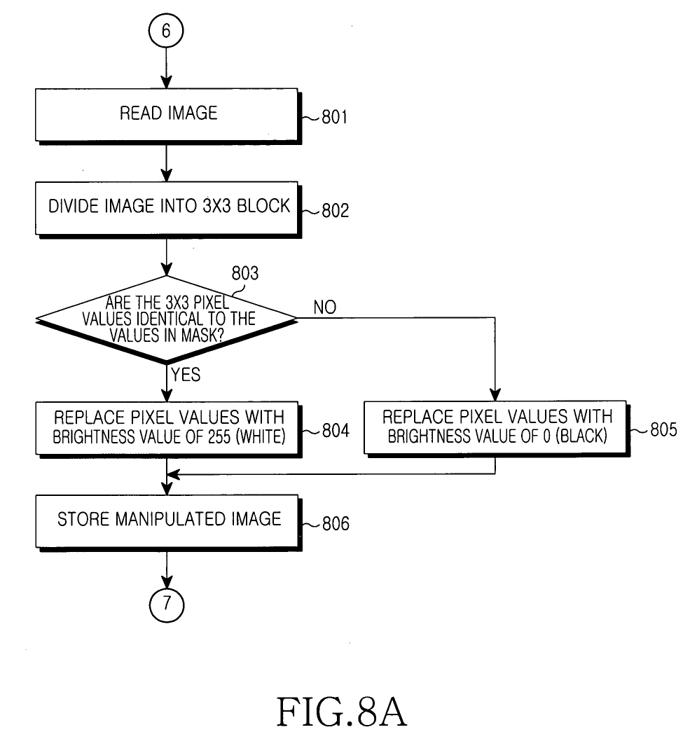

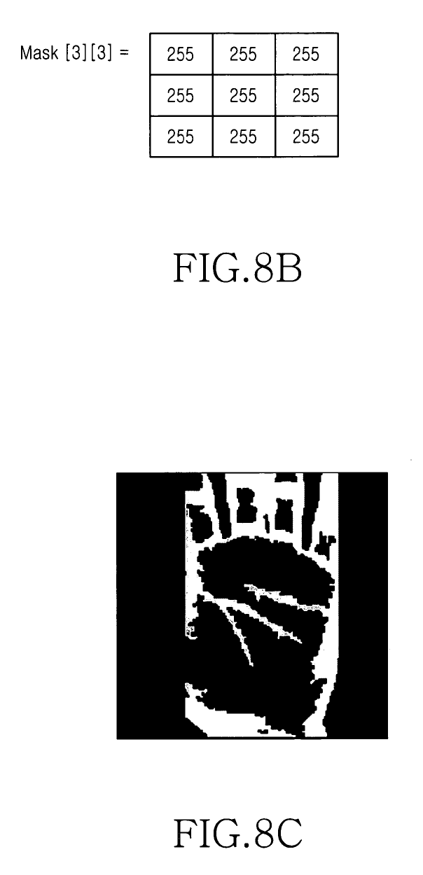

After completing the binarization, the control section 110 performs shape manipulation at step 800 to further clarify the embedded structure in the palm image. An embodiment of the present invention uses a morphology operation and more particularly an erosion operation for the shape manipulation. The erosion operation reduces the sizes of objects in an image by eliminating small-image object features, such as noise spikes between the objects and the background, or by expanding the background. When the erosion operation is performed on a binary image using an erosion mask as shown in FIG. 8B, one layer of pixels is removed from the periphery of each white object. FIG. 8A is a flow chart illustrating a process of performing an erosion operation on the palm image. Referring to FIG. 8A, the control section 110 reads the palm image stored in the memory 130 at step 801 and proceeds to step 802 to divide the palm image into 3×3 pixels. At step 803, the control section 110 determines whether the 3×3 pixel values are identical to the values in the erosion mask. If the 3×3 pixel values are identical to the values in the erosion mask, the control section 110 will detect this at step 803 and will proceed to step 804 to replace the pixel values with a brightness value of 255 (white). If the 3×3 pixel values are not identical to the values in the erosion mask, the control section 110 will detect this at step 803 and will proceed to step 805 to replace the pixel values with a brightness value of 0 (black). The palm image manipulated by the erosion operation is stored in the memory 130 at step 806. FIG. 8C shows the palm image manipulated by the erosion operation.

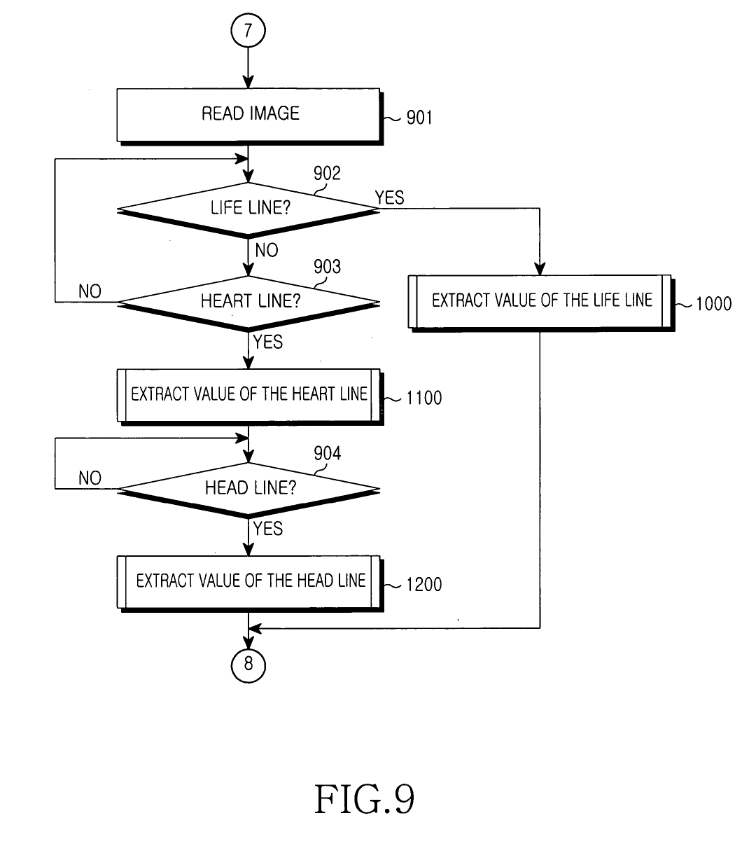

After the morphology operation, the control section 110 proceeds with step 900 to extract the life line, heart line and head line from the palm image. FIG. 9 is a flow chart showing a process of extracting the life line, heart line and head line. Referring to FIG. 9, the control section 110 reads the palm image stored in the memory 130 at step 901 and detects the life line, heart line and head line from the palm image.

To be specific, the control section 110 detects the life line at step 902 and proceeds with step 1000 to extract a value of the life line.

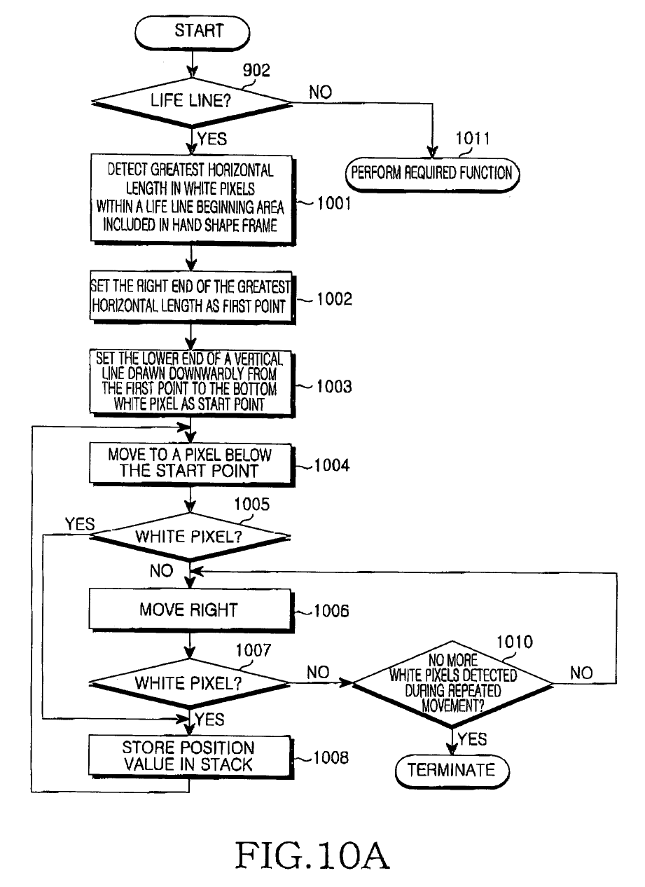

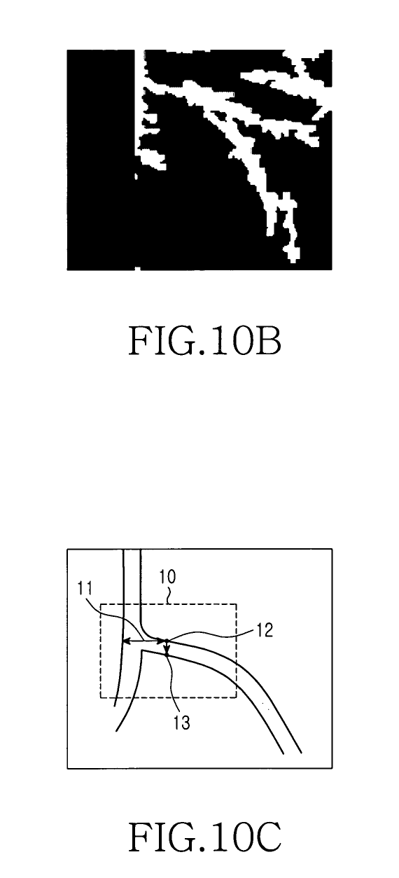

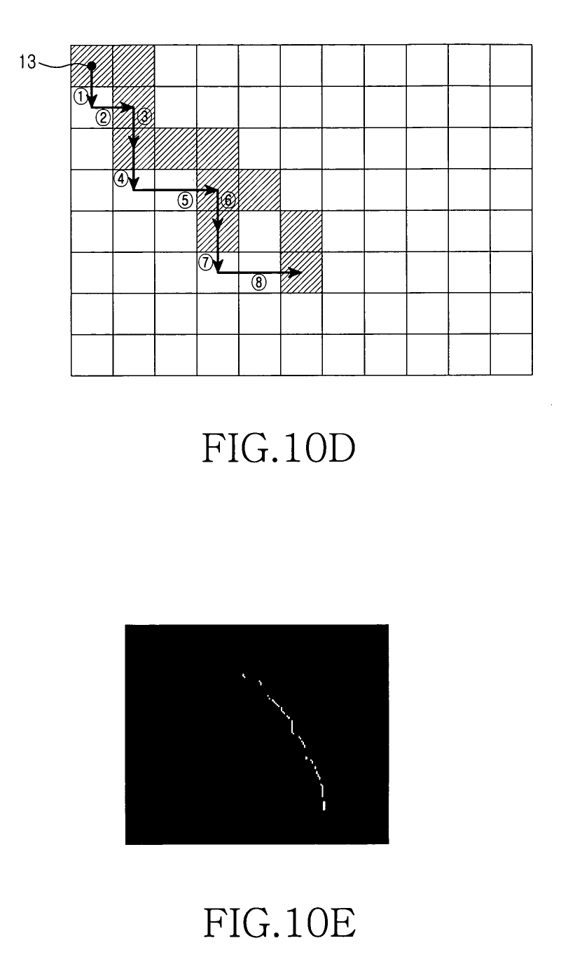

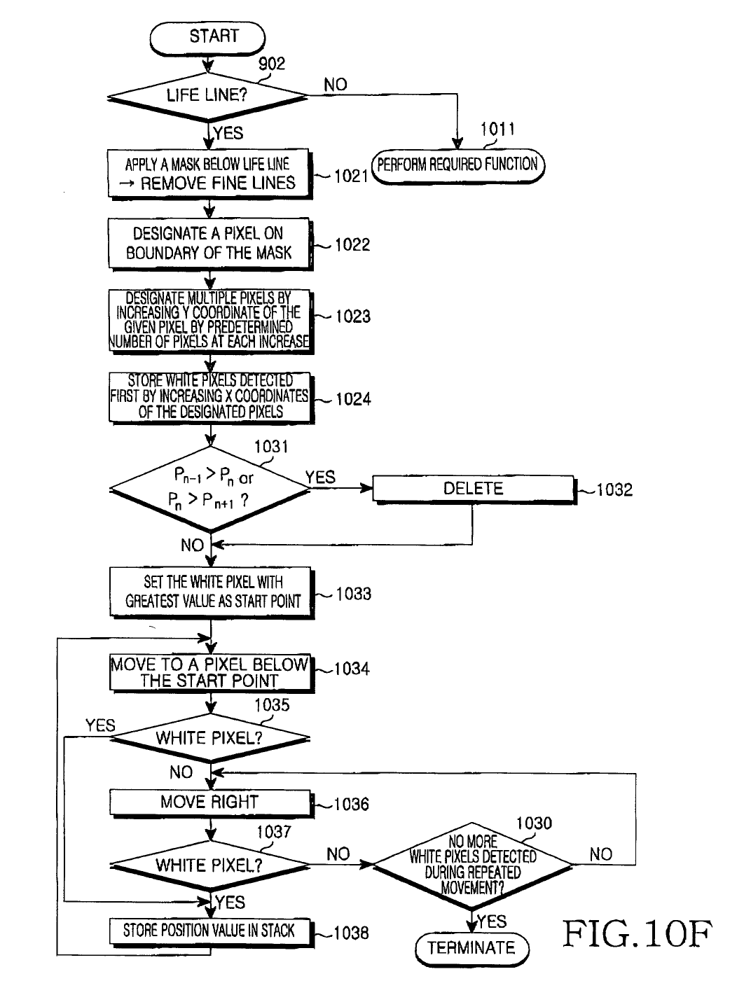

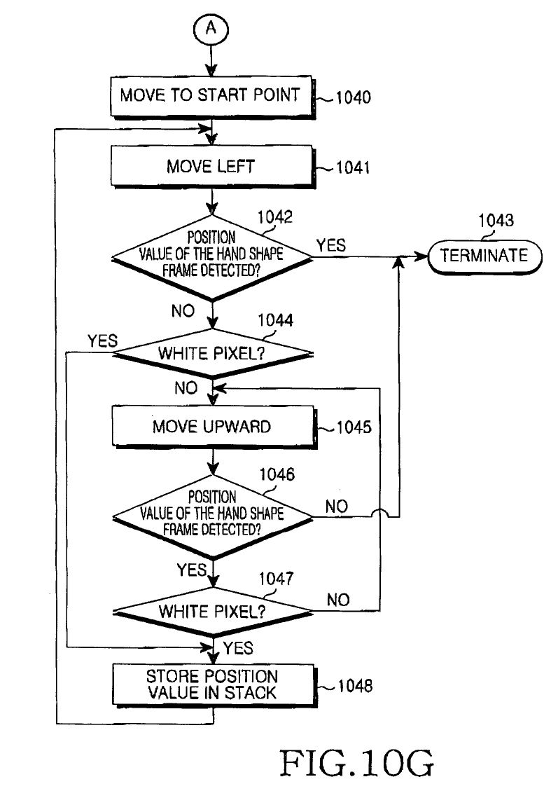

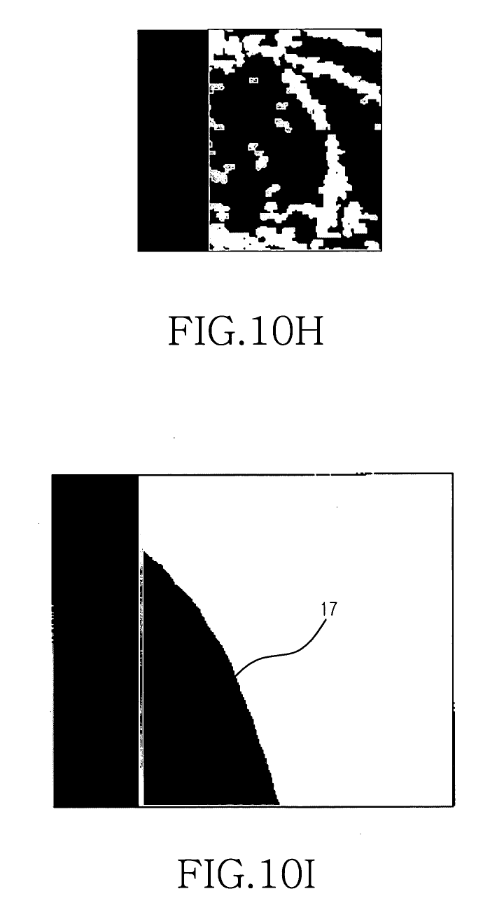

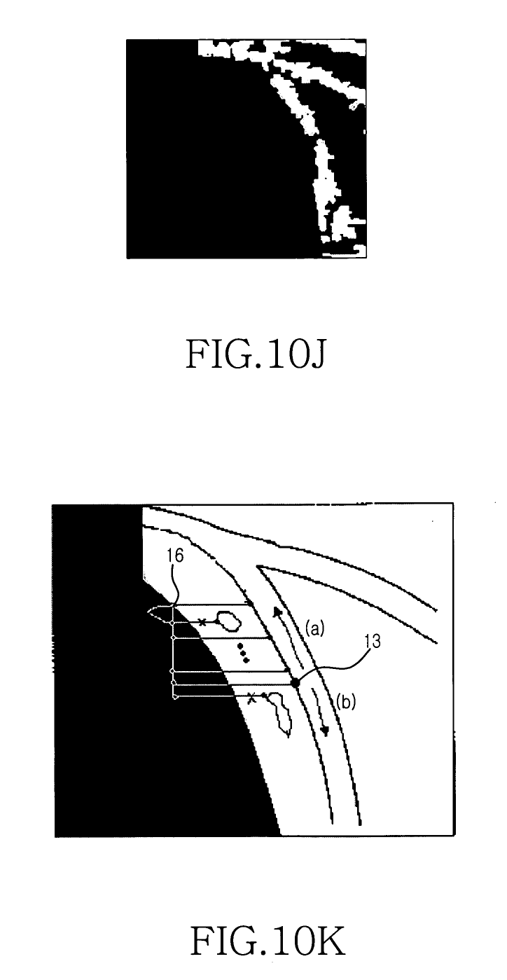

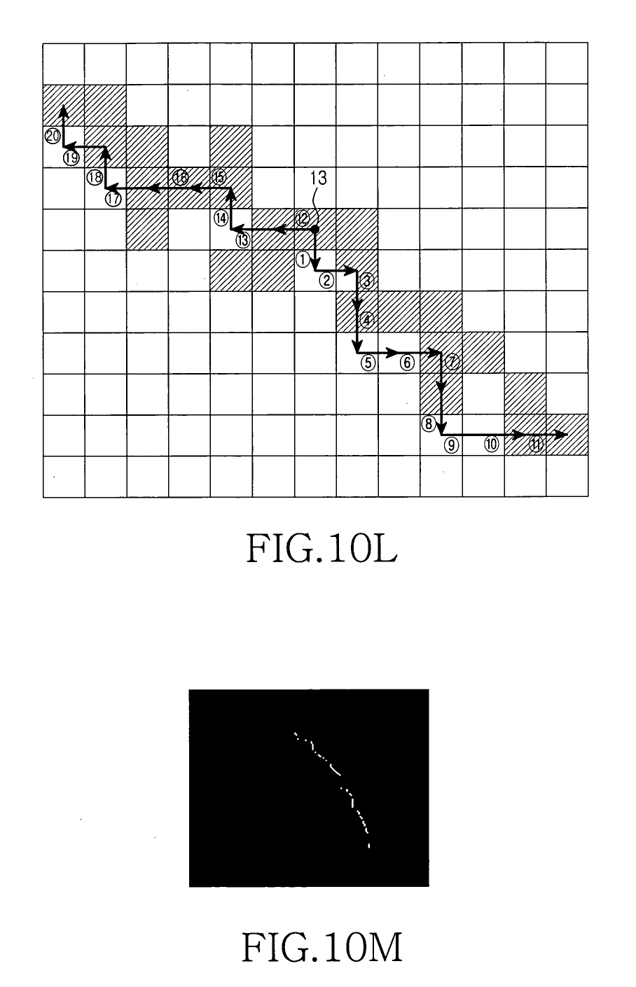

FIG. 10A is a flow chart showing a process of extracting a value of the life line in FIG. 9 according to another embodiment of the present invention. FIGS. 10B and 10C are views for explaining the process of FIG. 10A. FIG. 10D shows a movement for extracting the life line in FIG. 10A. FIG. 10E shows an image of the life line extracted according to FIG. 10A. FIGS. 10F and 10G are flow charts illustrating a process of extracting a value of the life line in FIG. 9 according to an embodiment of the present invention. FIGS. 10H through 10K are diagrams illustrating each process of FIGS. 10F and 10G. FIG. 10L illustrates a movement for extracting the life line in FIGS. 10F and 10G. FIG. 10M shows an image of the life line extracted according to the processes of FIGS. 10F and 10G.

Hereinafter, a process of extracting a value of the life line according to an embodiment of the present invention will be explained in detail with reference to FIGS. 10A through 10C. The control section 110 detects the start point of the life line. When the hand shape frame is displayed on the display section 160 at step 202, areas in which the life line, heart line and head line begin are indicated in the hand shape frame. The life line and the head line begin at the same start point. At step 902 if a search is not required for the lifeline, the process proceeds to step 1011 of FIG. 10A where other functions are performed. In order to find the start point of the life line, the control section 110 proceeds to step 1001 and detects the greatest horizontal length 11 in white pixels included in an area 10 in which the life line begins. At step 1002, the control section 110 sets the right end of the horizontal length 11 (see FIG. 10C) as a first point 12. At step 1003, the control section 110 sets the lower end of a vertical line, which is drawn downwardly from the first point 12 to the bottom white pixel contacting a black pixel, as a start point 13. The control section 110 proceeds to step 1004 to move to a pixel below the start point 13. If the pixel below the start point 13 is white, the control section 110 will detect this at step 1005 and will proceed to step 1008 to store the position value of the white pixel in a stack. The control section 110 will repeat step 1004 to move to another pixel in a downward direction. If that pixel is not white, the control section 110 will detect this at step 1005 and will proceed to step 1006 to move to a pixel on the right.

If the pixel on the right is white, the control section 110 will detect this at step 1007 and will store the position value of the white pixel in the stack at step 1008. The control section 110 will then repeat step 1004 to move to a lower pixel. If the pixel on the right of step 1006 is not white, the control section 110 will detect this at step 1007 and will return to step 1006 to move right. FIG. 10D is a view for explaining the movement over pixels in FIG. 10A, which starts from the start point 13. Referring to FIG. 10D, the control section 110 proceeds with step 1004 to move downward (direction \mathring{1}) to a pixel below the start point 13. Upon detecting that the pixel below the start point 13 is not white at step 1005, the control section 110 proceeds to step 1006 to move right (direction \mathring{2}). Upon detecting a white pixel in the right direction at step 1007, the control section 110 stores the position value of the white pixel in the stack at step 1008. Subsequently, the control section 110 repeats step 1004 to move downward (direction \mathring{3}). The control section 110 detects a white pixel in direction \mathring{3} at step 1005 and stores the position value of the white pixel in the stack at step 1008. The control section 110 repeats step 1004 again to move downward (direction \mathring{4}. The above steps of movement and storage of position values are repeated until no more white pixels are detected during movement over a predetermined number of pixels, for example, five pixels. If no more white pixels are detected, the control section 110 will detect this at step 1010 and will terminate the process of extracting the life line. FIG. 10E shows the life line extracted according to the process.

Hereinafter, a process of extracting a value of the life line according to the second embodiment of the present invention will be explained in detail with reference to FIGS. 10F through 10M. As a first step to detect the start point of the life line, the control section 110 proceeds with step 1021 and applies a mask 17 as shown in FIG. 10I to the area below the life line in FIG. 10H to eliminate fine lines. The mask 17 used at step 1021 covers the area below the life line. Assuming that the full size of the image is 352×288 pixels, X and Y values (pixels) of the mask 17 applied to the area below the life line are as follows.
Y value of the mask: 113 to 288
X value of the mask: f(x)=−0.016 x²+1.58 X+175

The pixels applied by the mask are all converted to a value of “0” (black), thereby generating an image with fine lines removed as shown in FIG. 10J.

After application of the mask 17, the control section 110 proceeds to step 1022 to designate a pixel 16 positioned on the boundary of the mask 17 that faces the life line. It is assumed that the pixel 16 has coordinates (X, Y)=(70, 130) which correspond to one tenth of the Y axis of the mask 17. At step 1023, the control section 110 designates a plurality of pixels by increasing the Y coordinate of the given pixel 16 by a predetermined number of pixels at each increase. It is assumed that the Y coordinate is increased by every five pixels until twelve pixels are designated. After designation of twelve pixels, the control section 110 proceeds to step 1024 to store white pixels, each of which is detected first by increasing the X coordinates of the twelve pixels. If any of the twelve stored white pixels, and so on, any current pixel Pₙ, has a value (X coordinate) smaller than the pevious pixel Pₙ₋₁ or greater than the next pixel Pₙ₊₁, the control section 110 will detect this at step 1031 and will proceed to step 1032 to delete the pixel. In view of the basic pattern of the life line, the stored white pixels should have gradually increasing values. If any white pixel has a value smaller than the previous one or greater than the next one, it does not meet the basic pattern of the life line and is thus deleted. Thus, for example, assuming that the twelve white pixels stored at step 1024 have the following values (X coordinates):
80, 85, 82, 100, 120, 130, 150, 140, 155, 160, 170, 165,
three white pixels of values “85,” “150” and “165” are deleted at step 1032. The value “85” is greater than “82” of the next white pixel. The value “150” is greater than “140” of the next white pixel. Also, the value “165” is smaller than “170” of the previous white pixel. After deleting the three white pixels, the control section 110 proceeds to step 1033 to set the white pixel with the greatest X coordinate “170” as the start point 13.

The start point 13 can be set in any position of the life line. In order to extract a value of the life line, two consecutive steps of line detection in (a) direction and line detection in (b) direction, or vice versa, are performed. In an embodiment of the present invention, it is assumed that detection in (b) direction procedes detection in (a) direction.

The control section 110 proceeds with step 1034 to move to a pixel below the start point 13. If the pixel below the start point 13 is white, the control section 110 will detect this at step 1035 and will proceed to step 1038 to store the position value of the white pixel in a stack. The control section 110 will repeat step 1034 to move to another pixel in a downward direction. If that pixel is not white, the control section 110 will detect this at step 1035 and will proceed to step 1036 to move to a pixel on the right.

If the pixel on the right is white, the control section 110 will detect this at step 1037 and will store the position value of the white pixel in the stack at step 1038. The control section 110 will then repeat step 1034 to move to a lower pixel. If the pixel on the right of step 1036 is not white, the control section 110 will detect this at step 1037 and will return to step 1037 to move right. The steps of movement and storage of position values are repeated until no more white pixels are detected during movement over a predetermined number of pixels, for example, five pixels. If no more white pixels are detected, the control section 110 will detect this at step 1030 and will move to the start point 13 at step 1040.

At step 1041, the control section 110 moves to a pixel on the left from the start point 13. If the pixel on the left is white, the control section 110 will detect this at step 1042 and will proceed to step 1048 to store the position value of the white pixel in the stack. The control section 110 will repeat step 1041 to move to another pixel in the left direction. If that pixel is not white, the control section 110 will detect this at step 1044 and will proceed to step 1045 to move to a pixel in the upward direction.

If the upper pixel is white, the control section 110 will detect this at step 1047 and will store the position value of the white pixel in the stack at step 1048. The control section 110 will then repeat step 1041 to move to a pixel on the left.

If the upper pixel of step 1041 is not white, the control section 110 will detect this at step 1044 and will return to step 1045 to move upward. The steps of movement and storage of position values are repeated until a position value of the hand shape frame is detected. The control section 110 detects the position value of the hand shape frame at step 1042 or 1046 and terminates the process of extracting the life line at step 1043.

FIG. 10J is a view for explaining the process of extracting the life line by the movement over pixels, which starts from the start point 13. Referring to FIG. 10J, the control section 110 proceeds to step 1034 to move downward (direction \mathring{1} to a pixel below the start point 13. Upon detecting that the pixel below the start point 13 is not white at step 1035, the control section 110 proceeds to step 1036 to move right (direction \mathring{2}). Upon detecting a white pixel in the right direction at step 1037, the control section 110 stores the position value of the white pixel in the stack at step 1038. Subsequently, the control section 110 repeats step 1034 to move downward (direction \mathring{3}. The control section 110 detects a white pixel in direction \mathring{3} at step 1036 and stores the position value of the white pixel in the stack at step 1038. The control section 110 repeats step 1034 again to move downward (direction \mathring{4}. The above steps of movement and storage of position values are repeated until no more white pixels are detected during movement over a predetermined number of pixels, for example, five pixels. If no more white pixels are detected, the control section 110 will detect this at step 1030 and will move to the start point 13 at step 1040.

The control section 110 proceeds to step 1041 to move to the left (direction \mathring{12}) from the start point 13. Upon detecting a white pixel in direction \mathring{12} at step 1044, the control section 110 proceeds to step 1048 to store the position value of the white pixel in the stack. The control section 110 repeats step 1041 to move to another pixel in the left direction (direction \mathring{13}). The control section detects that the pixel on the left is not white at step 1044 and proceeds to step 1045 to move upward (direction \mathring{14}). Upon detecting a white pixel in direction \mathring{14} at step 1047, the control section 110 stores the position value of the white pixel in the stack at step 1048. The control section 110 repeats step 1041 again to move left (direction \mathring{15}). The steps of movement and storage of position values are repeated until a position value of the hand shape frame is detected. The control section 110 detects the position value of the hand shape frame at step 1042 or 1046 and terminates the process of extracting the life line. FIG. 10L shows the life line extracted by the process.

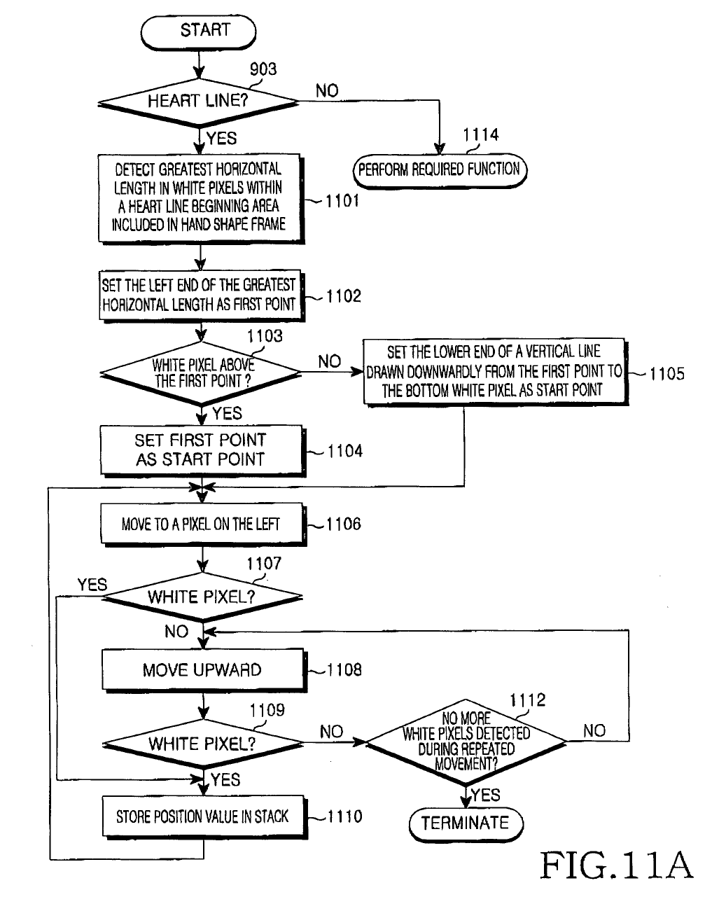

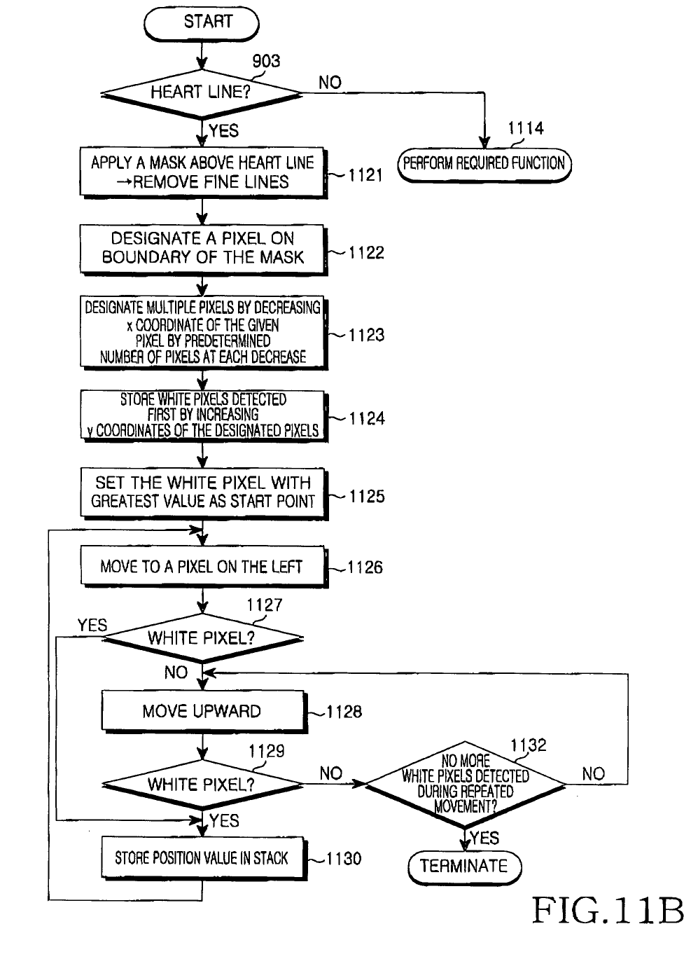

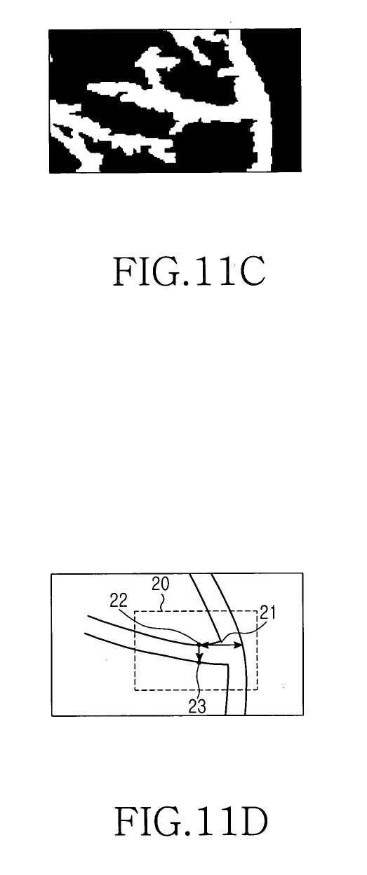

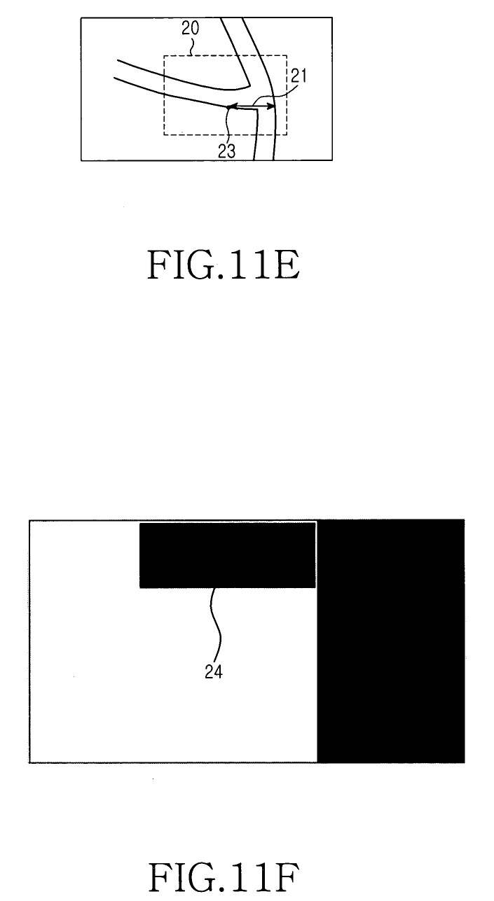

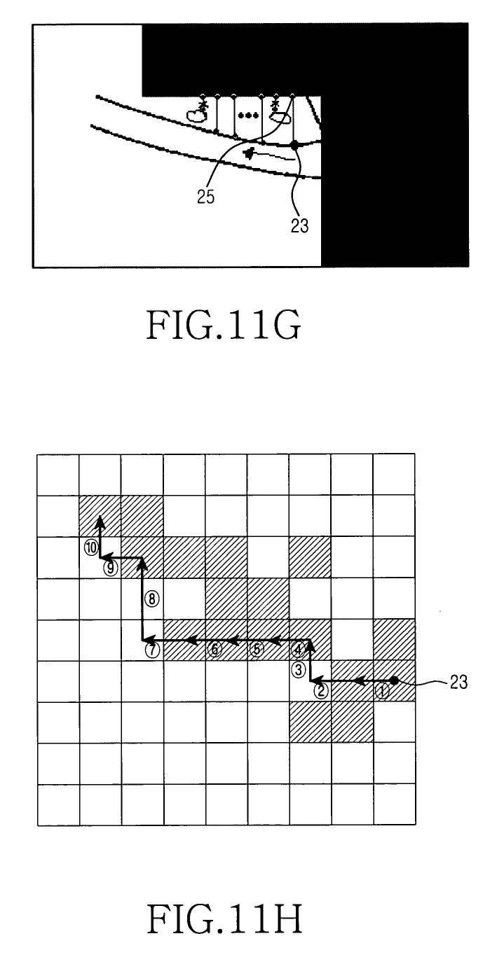

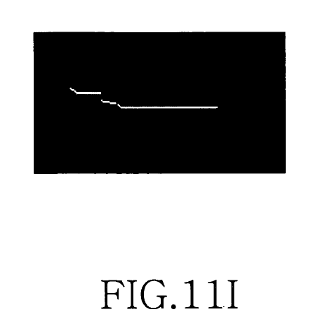

Hereinafter, a process of extracting the heart line according to the first embodiment of the present invention will be explained in detail with reference to FIGS. 11A through 11E, 11H and 11I. At step 903 a determination is made as to whether a heart line needs to be analyzed. If the answer is no the process proceeds to step 1114. If the answer is yes the process proceeds to step 1101. When the hand shape frame is displayed, the control section 110 proceeds to step 1101 to detect the greatest horizontal length 21 in white pixels included in an area 20 in which the heart line begins. At step 1102, the control section 110 sets the left end of the horizontal length 21 as a first point 22 (see FIG. 11D). The control section 110 detects whether a pixel above the first point 22 is white. If a pixel above the first point 22 is not white, the control section 110 will detect this at step 1103 and will proceed to step 110s to set the lower end of a vertical line, which is drawn downwardly from the first point 22 to the bottom white pixel contacting a black pixel, as a start point 23. If a pixel above the first point 22 is white as shown in FIG. 11E, the control section 110 will detect this at step 1103 and will proceed to step 1104 to set the first point 22 as the start point 23.

At step 1106, the control section 110 moves to a pixel on the left from the start point 23. If the pixel on the left is white, the control section 110 will detect this at step 1107 and will proceed to step 1110 to store the position value of the white pixel in the stack. The control section 110 will repeat step 1106 to move to another pixel in the left direction. If that pixel is not white, the control section 110 will detect this at step 1107 and will proceed to step 1108 to move upward. If the upper pixel is white, the control section 110 will detect this at step 1109 and will store the position value of the white pixel in the stack at step 1110. The control section 110 will then repeat step 1106 to move to a pixel on the left. If the upper pixel of step 1108 is not white, the control section 110 will detect this at step 1109 and will return to step 1108 to move upward.

Hereinafter, a process of extracting the heart line according to another embodiment of the present invention will be explained in detail with reference to FIGS. 11B, 11C and 11F through 11I. At step 903 a determination is made as to whether a heart line needs to be analyzed. If the answer is no the process proceeds to step 1114. If the answer is yes the process proceeds to step 1121. As a first step to detect the start point for extracting the life line, the control section 110 proceeds to step 1121 and applies a mask 24 to the area above the heart line to eliminate fine lines. The mask 24 used at step 1121 covers the area above the heart line. Assuming that the full size of the image is 352×288 pixels, the mask 24 has a rectangular area of the following X and Y values (pixels).
Y value of the mask: 0 to 84
X value of the mask: 199 to 308

The pixels applied by the mask 24 are all converted to a value of “0” (black), thereby generating an image as shown in FIG. 11G with fine lines removed from the source image of FIG. 11C.

After application of the mask 24, the control section 110 proceeds to step 1122 to designate a pixel 25 positioned on the boundary of the mask 24 that faces the heart line. It is assumed that the pixel 25 has coordinates (X, Y)=(300, 85) which correspond to one tenth of the X axis of the mask 24. At step 1123, the control section 110 designates a plurality of pixels by decreasing the X coordinate of the given pixel 25 by a predetermined number of pixels for each decrease. It is assumed that the X coordinate is decreased by every 10 pixels until ten pixels are designated. After designation of ten pixels, the control section 110 proceeds to step 1124 to store white pixels, each of which is detected first by increasing the Y coordinates of the ten pixels. Assuming that the ten white pixels stored at step 1124 have the following values (Y coordinates):
100, 83, 92, 88, 99, 103, 105, 98, 90 and 101,
a white pixel having the greatest value “105” is set as a start point 23 for extracting the heart line at step 1125.

The control section 110 proceeds to step 1126 to move to a pixel on the left from the start point 23. If the pixel on the left is white, the control section 110 will detect this at step 1127 and will proceed to step 1130 to store the position value of the white pixel in the stack. The control section 110 will repeat step 1126 to move to another pixel in the left direction. If the pixel on the left is not white, the control section 110 will detect this at step 1127 and will proceed to step 1128 to move upward. If the upper pixel is white, the control section 110 will detect this at step 1129 and will store the position value of the white pixel in the stack at step 1130. The control section 110 will then repeat step 1126 to move to a pixel on the left. If the upper pixel of step 1128 is not white, the control section 110 will detect this at step 1129 and will proceed to step 1132 to determine if no more white pixels are detected during repeated movements. If no more white pixels are detected the process terminates. If more white pixels are determined the process returns to step 1128 to move upward.

FIG. 11H is a view for explaining the process of extracting the heart line by the movement over pixels, which starts from the start point 23. Referring to FIG. 11H, the control section 110 proceeds to step 1106 to move to the left (direction \mathring{1}) from the start point 23. Upon detecting a white pixel in direction \mathring{1} at step 1107, the control section 110 proceeds to step 1110 to store the position value of the white pixel in the stack. The control section 110 repeats step 1106 to move to another pixel in the left direction (direction \mathring{2}). The control section detects that the pixel on the left is not white at step 1107 and proceeds to step 1108 to move upward (direction \mathring{3}. Upon detecting a white pixel in direction \mathring{3} at step 1109, the control section 110 stores the position value of the white pixel in the stack at step 1110. The control section 110 repeats step 1106 again to move left (direction \mathring{4}. The steps of movement and storage of position values are repeated until no more white pixels are detected during movement over a predetermined number of pixels, for example, five pixels. If no more white pixels are detected, the control section 110 will detect this at step 1112 and will terminate the process of extracting the heart line. FIG. 11I shows the heart line extracted according to the process.

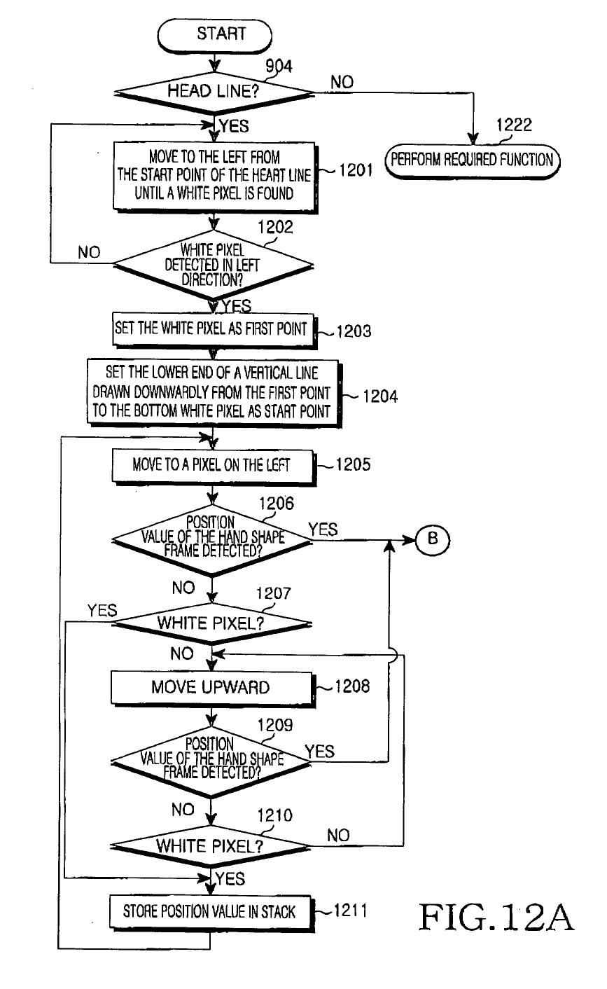

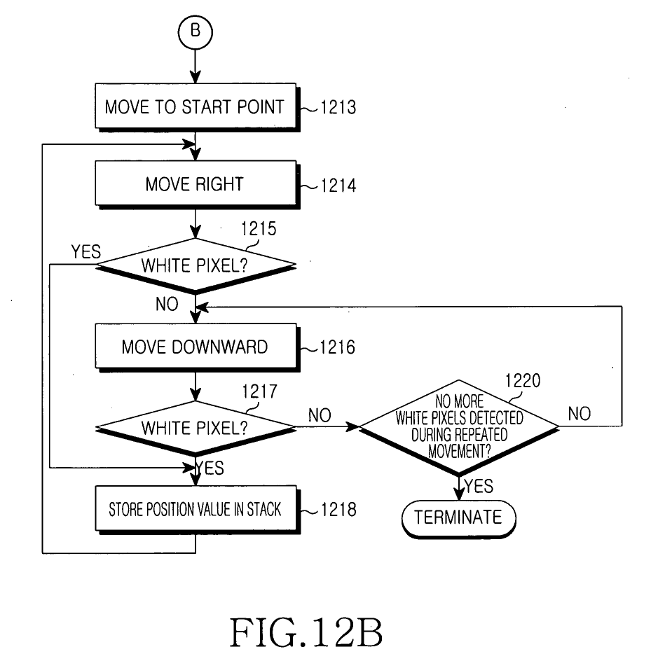

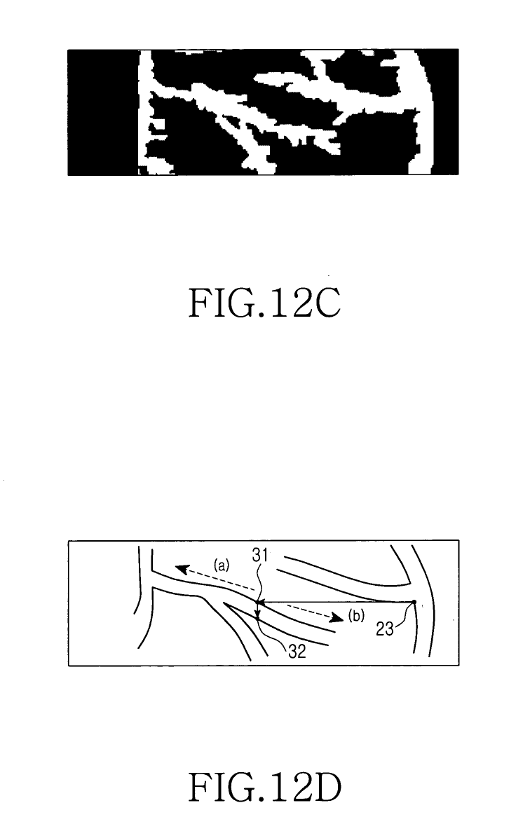

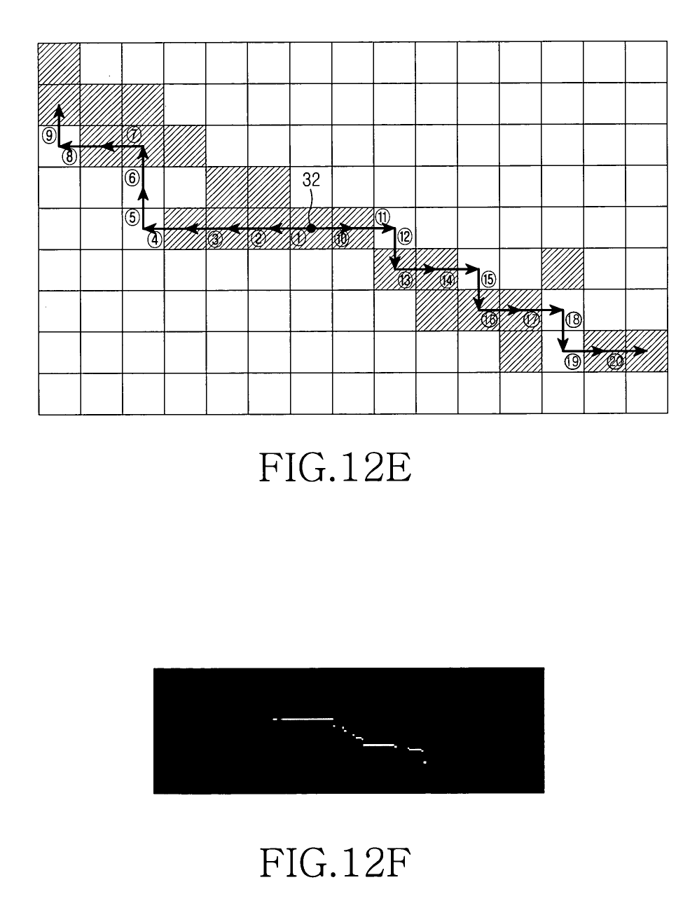

The control section 110 detects the termination of the process of extracting the heart line at step 904 and proceeds with step 1200 to extract a value of the head line. FIGS. 12A and 12B are flow charts illustrating a process of extracting a value of the head line. FIGS. 12C and 12D are views for explaining how to detect a start point for extracting the head line. At step 904 a determination is made as to whether a head line needs to be analyzed. If the answer is no the process proceeds to step 1222. If the answer is yes the process proceeds to step 1201. Referring to FIGS. 12A through 12D, the control section 110 first detects the start point 23 of the heart line and then proceeds with step 1201 to move to the left from the start point 23 of the heart line until a white pixel is found. Upon detecting a white pixel in the left direction at step 1202, the control section 110 proceeds with to 1203 to set the white pixel as a first point 31. At step 1204, the control section 110 sets the lower end of a vertical line, which is drawn downwardly from the first point 31 to the bottom white pixel contacting a black pixel, as a start point 32. The start point 32 has a fixed X coordinate in the range of 250 to 270 pixels. The Y coordinate of the start point 32 is a value of the Y coordinate of the start point 23 of the heart line plus a predetermined number of pixels (about 20 pixels) along the Y axis. Since the start point 32 can be set in any position of the head line, two consecutive steps of head line detection in (a) direction and detection in (b) direction, or vice versa, are performed. In an embodiment of the present invention, it is assumed that the head line is detected in (a) direction first.

The control section 110 proceeds to step 1205 to move to a pixel on the left from the start point 32. If the pixel on the left is white, the control section 110 will detect this at step 1207 and will proceed to step 1211 to store the position value of the white pixel in the stack. The control section 110 will repeat step 1205 to move to another pixel in the left direction. If the pixel on the left is not white, the control section 110 will detect this at step 1207 and will proceed to step 1208 to move to a pixel in the upward direction.

If the upper pixel is white, the control section 110 will detect this at step 1210 and will store the position value of the white pixel in the stack at step 1211. The control section 110 will then repeat step 1205 to move to a pixel on the left.

If the upper pixel of step 1208 is not white, the control section 110 will detect this at step 1210 and will return to step 1208 to move upward. The steps of movement and storage of position values are repeated until a position value of the hand shape frame is detected. The control section 110 detects the position value of the hand shape frame at step 1206 or 1209 and terminates the process of detecting the head line in (a) direction. The control section 110 returns to the start point 32 at step 1213.

The control section 110 proceeds to step 1214 to move to a pixel on the right from the start point 32. If the pixel on the right is white, the control section 110 will detect this at step 1215 and will proceed to step 1218 to store the position value of the white pixel in the stack. The control section 110 will repeat step 1214 to move to another pixel in the right direction. If the pixel on the right is not white, the control section 110 will detect this at step 1215 and will proceed to step 1216 to move to a pixel in the downward direction.

If the lower pixel is white, the control section 110 will detect this at step 1217 and will store the position value of the white pixel in the stack at step 1218. The control section 110 will then repeat step 1214 to move to a pixel on the right. If the lower of step 1216 is not white, the control section 110 will detect this at step 1217 and will proceed to step 1220 to determine if any more white pixels are detected during repeated movements. If no more white pixels are detected the process terminates the process of extracting the head line. If more white pixels are determined the process returns to step 1216 to move downward. The steps of movement and storage of position values are repeated until no more white pixels are detected during movement over a predetermined number of pixels, for example, five pixels.

FIG. 12E is a view for explaining the process of extracting the head line by the movement over pixels, which starts from the start point 32. Referring to FIG. 12E, the control section 110 proceeds to step 1205 to move to the left (direction \mathring{1}) from the start point 32. Upon detecting a white pixel in direction \mathring{1} at step 1207, the control section 110 proceeds to step 1211 to store the position value of the white pixel in the stack. The control section 110 repeats step 1205 to move to another pixel in the left direction (direction \mathring{2}). Upon detecting a white pixel in direction \mathring{2} at step 1207, the control section 110 proceeds with step 1211 to store the position value of the white pixel in the stack. The control section 110 repeats step 1205 to move to another pixel in the left direction (direction \mathring{3}). The control section detects that the pixel on the left is also white at step 1207 and stores the position value of the pixel at step 1211. The control section 110 repeats step 1205 to move to another pixel in the left direction (direction \mathring{4}). The control section 110 detects that the pixel on the left is not white at step 1207 and proceeds with step 1208 to move upward (direction \mathring{5}). The control section 110 detects that the upper pixel is not white at step 1210 and returns to step 1208 to move upward (direction \mathring{6}). Upon detecting a white pixel in direction \mathring{7} at step 1210, the control section 110 stores the position value of the white pixel in the stack at step 1211. The control section 110 repeats step 1205 again to move left (direction \mathring{7}). The steps of movement and storage of position values are repeated until a position value of the hand shape frame is detected. The control section 110 detects the position value of the hand shape frame at step 1206 or 1209 and terminates the process of detecting the head line in (a) direction. The control section 110 returns to the start point 32 at step 1213.

The control section 110 proceeds to step 1214 to move to the right (direction \mathring{10}) from the start point 32. Upon detecting a white pixel in direction \mathring{10} at step 1215, the control section 110 proceeds to step 1218 to store the position value of the white pixel in the stack. The control section 110 repeats step 1214 to move to another pixel in the right direction (direction \mathring{11}). The control section 110 detects that the pixel on the right is not white at step 1215 and proceeds to step 1216 to move to a pixel in the downward direction (direction \mathring{12}). Upon detecting a white pixel in direction \mathring{12} at step 1217, the control section stores the position value of the white pixel in the stack at step 1218. The control section 110 repeats step 1214 to move right (direction \mathring{13}). Upon detecting a white pixel in direction \mathring{13} at step 1215, the control section 110 stores the position value of the pixel in the stack at step 1218. The control section 110 repeats step 1214 again to move right (direction \mathring{14}). The steps of movement and storage of position values are repeated until no more white pixels are detected during movement over a predetermined number of pixels, for example, five pixels. If no more white pixels are detected, the control section 110 will detect this at step 1220 and will terminate the process of extracting the head line. FIG. 12F shows the head line extracted according to the above process.

After extracting the life line, heart line and head line, the control section 110 proceeds with step 1300 and performs interpolation to obtain the length and slope of each line of the palm. In the preferred embodiments of the present invention, palm reading results are output based on the length of the heart line, as well as the lengths and slopes of the life line and the head line. Also, Lagrange polynomials are used to implement interpolation of the palm lines. The Lagrange interpolation will be explained below in detail.

A polynomial of degree n which passes through “n+1” data points (xᵢ,yᵢ) is defined as:
f(x)=a₀+a₁x+a₂x²+ . . . +aₙxⁿ (1)

Since the polynomial (1) passes through all the data points, formula (2) is obtained:
f(xᵢ)=yᵢ(I=0,1, . . . n) (2)

To construct a polynomial, the Lagrange polynomial Li(x) of order n is used:
f(x)=L₀(x)y₀+L₁(x)y₁+ . . . +Lₙ(x)yₙ (3a)

$${L}_{i} ( x ) - \{ \begin{matrix}0 ; & i \neq j \\ 1 ; & i = j\end{matrix} \qquad ( 3 b )$$

The Lagrange polynomial which satisfies the above conditions is given by:

$$\begin{matrix}{L}_{i} ( x ) - \frac{( x - {x}_{0} ) ( x - {x}_{1} ) ⋯ ( x - {x}_{i - 1} ) ( x - {x}_{i + 1} ) … ( x - {x}_{n} )}{( {x}_{i} - {x}_{0} ) ( {x}_{i} - {x}_{1} ) ⋯ ( {x}_{i} - {x}_{i - 1} ) ( {x}_{i} - {x}_{i + 1} ) ⋯ ( {x}_{i} - {x}_{n} )} = \\ {\prod }_{{j = 0}_{j \neq 0}}^{n} [ \frac{x - {x}_{i}}{{x}_{i} - {x}_{j}} ]\end{matrix} \qquad ( 4 )$$

The interpolating polynomial (3a) can be represented in form of the polynomial (1). A single polynomial (5) is produced from the two polynomials (3a) and (3b):

$$\begin{matrix}( {a}_{0} + {a}_{1} x + {a}_{2} {x}^{2} + ⋯ + {a}_{n} {x}^{n} ) ( {b}_{0} + {b}_{1} x + {b}_{2} {x}^{2} + ⋯ + {b}_{m} {x}^{m} ) = \\ ( {a}_{0} - {b}_{0} ) + ( {a}_{0} {b}_{1} + {a}_{1} {b}_{0} ) x + ( {a}_{0} {b}_{2} + {a}_{1} {b}_{1} + {a}_{2} {b}_{0} ) {x}^{2} + ⋯ \\ ( ⋯ ) {x}^{n + m} = \\ {\sum }_{i = 0}^{n + m} ( {\sum }_{j = 0}^{i} {a}_{j} {b}_{i - j} ) {x}^{2}\end{matrix} \qquad ( 5 )$$

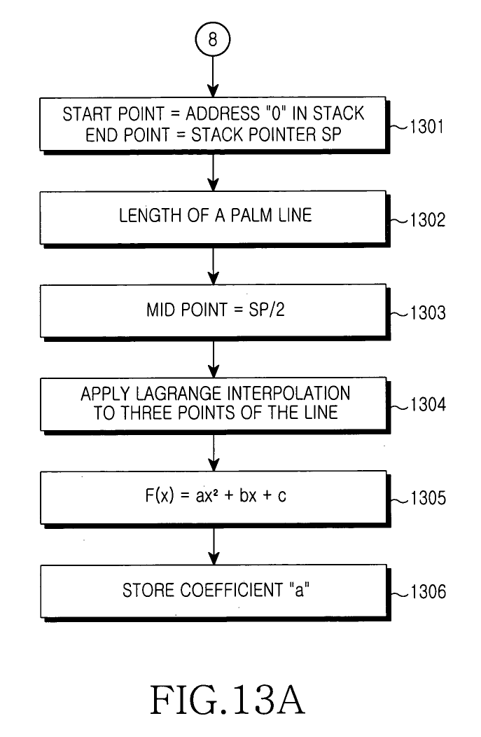

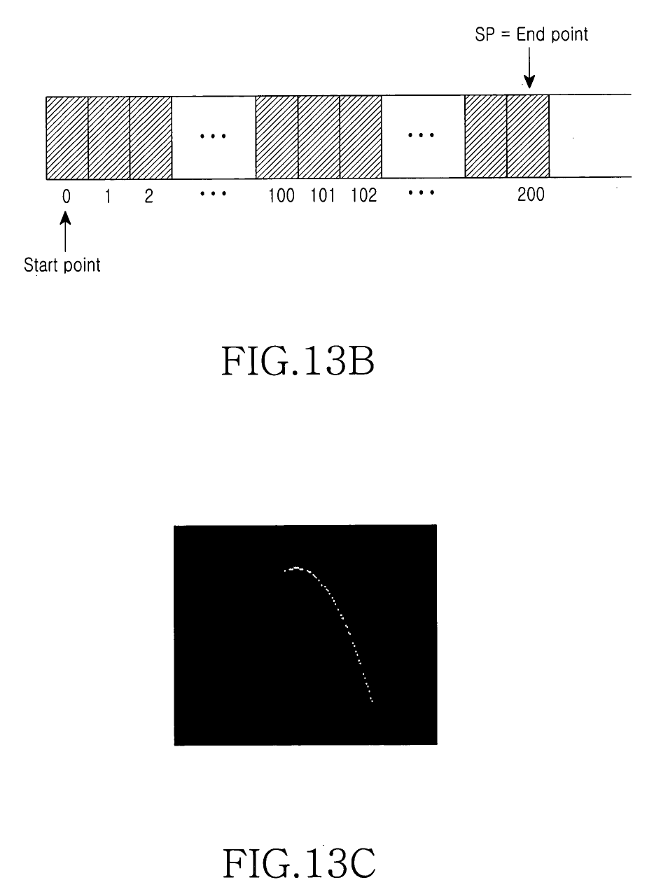

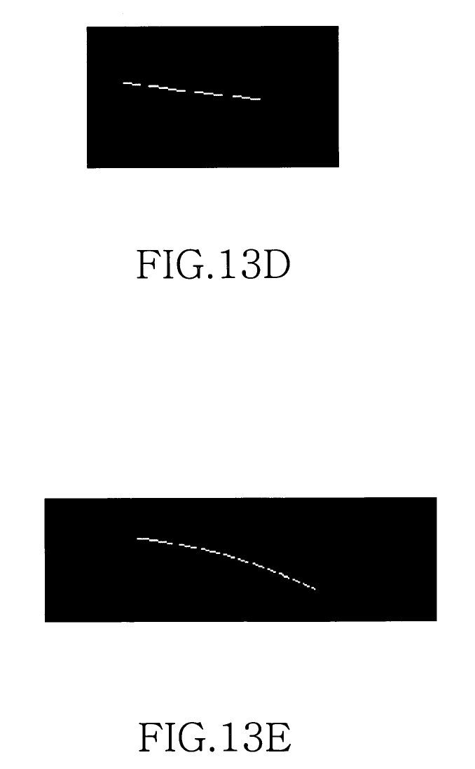

FIG. 13A is a flow chart illustrating an interpolation process for obtaining the lengths or slopes of the life line, heart line and head line of the palm. FIG. 13B shows the structure of a stack storing the values of the life line, heart line and head line.

Referring to FIG. 13A, the control section 110 proceeds to step 1301 to find the start and end points of the life line through the stack storing the value of the life line. As shown in FIG. 13B, the start point of the life line is addressed as “0” in the stack. The end point of the life line is the final storage address indicated by a stack pointer SP. The control section 110 obtains the length of the life line based on the start and end points at step 1302. Subsequently, the control section 110 proceeds to step 1303 to determine the middle point which is a half of the stack pointer SP. Lagrange interpolation is applied to the three points of the life line at step 1304, thereby producing the quadratic equation “f(x)=ax²+bx+c” at step 1305. The coefficient “a” represents a slope. The control section 110 stores the coefficient “a” in the memory 130 at step 1306. FIG. 13C shows the life line extracted by interpolation.

The length of the heart line is obtained using the stack storing the value of the heart line. FIG. 13D shows the heart line extracted by interpolation. The length and slope of the head line are also obtained using the stack storing the value of the head line. FIG. 13E shows the head line extracted as a result of interpolation.

After obtaining the length of the heart line, as well as the lengths and slopes of the life line and the head line, at step 1300, the control section proceeds to output results of the palm reading.

It is assumed that the life line has a length in any of three ranges (less than 120 pixels, between 120 and 160 pixels, and over 160 pixels) and a slope in any of three ranges (less than 8°, between 8° and 32°, above 32°). It is also assumed that the head line has a length in any of three ranges (less than 80 pixels, between 80 and 160 pixels, and over 160 pixels) and a slope in any of two ranges (less than 1.845° and over 1.845°). It is also assumed that the heart line has a length in any of four ranges (less than 80 pixels, between 80 and 140 pixels, 140 and 200 pixels, and over 200 pixels).

Assuming that the life line has a 170-pixel length and a 36° slope, the head line has a 150-pixel length and a 1.820° slope, and the heart line has a 160-pixel length, the control section 110 obtains such data at step 1300 and proceeds to display the following results of palm reading on the display section 160:

[Health] You are precocious, dynamic and positive in all activities. Experiencing romance many times, you have lots of lovers and children. You may begin with various fields of business. Even in trouble, you exert great energy to overcome the trouble, without being pessimistic.

[Intellect] You are fast-thinking, quick-witted, sharp and good at figures. You have a talent for business and make accurate judgements with mathematical ideas. You are a real wheeler-dealer and take care of your own business well. Although great success is expected particularly in business or the legal profession, you will be recognized as a brilliant and talented person in every field. If double overlapping head lines appear, you are really a genius having an eye for observation. You are really quick-witted in sudden unexpected incidents and competent to do practical business.

[Character] You are sincere, cheerful and intelligent. Maintaining both great love and great friendship, you devote yourself to helping your friends. You hate to lose. You are conservative and respect your elders and ancestors. You hesitate to tell your mind, but you have patience and a strong sense of responsbility. You may be selfish in some aspects. You are sensitive and have an artistic talent. As a warm-hearted person taking care of close associates, you are always surrounded by people. You have a large number of acquaintances of the same sex, rather than of the opposite sex.

[Love] You are attractive as a person of few words. Since you are too alert to express your mind, you may have difficulty in attaining love. If you are a woman, you are prudish. With wishes for many things and great dreams, you like spending time in imagination. You are usually soft and calm. However, you can be an outspoken person or a chaste and modest lady according to surroundings. Your weakest point is that you are too slow in thinking and action. If you are a man, you look gentle and conceal your wishes in mind. Sometimes, you need to express your wishes and show yourself exactly as you are. It is not good to be two-faced. In any case, you are very attractive.

After steps 204 and 300, the control section 110 may perform steps 500 and 900 to 1300. Alternatively, steps 500, 700 and 900 to 1300 may follow after steps 204 and 300.

If an incoming call signal is received during the process of extracting the lines of the palm, the control section 110 will detect the signal and will change the current mode of the mobile terminal to a call mode. Upon termination of the call mode, the control section 110 will resume the process of extracting the lines of the palm.

Although embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

The present invention offers an entertaining pastime to amuse the user with palm reading through a mobile terminal, regardless of time and place.

1. A method for reading a user's palm using a mobile terminal by extracting a life line, a heart line and a head line from the palm, comprising the steps of:
photographing the user's palm when the mobile terminal is in a palm photograph mode;
converting the photographed palm image to a grayscale image;
detecting edges in the palm image;
extracting a value of each line from the palm;
obtaining a length and a slope of each line of the palm based on the extracted value; and
outputting results of the palm reading based on the length and slope of each line of the palm.

2. The method according to claim 1, wherein a hand shape frame is displayed in said palm photograph mode.

3. The method according to claim 2, wherein said hand shape frame comprises an area in which the life line, the head line begin and the heart line begin.

4. The method according to claim 1, wherein said step of converting the photographed palm image to a grayscale image comprises:
reading the photographed palm image;
eliminating a predetermined area of left and right sides of the read palm image; and
converting the palm image excluding the eliminated area to a grayscale image.

5. The method according to claim 1, further comprising the step of enhancing image contrast after converting the photographed palm image to the grayscale.

6. The method according to claim 1, further comprising the steps of:
removing fine lines in the palm image;
binarizing the palm image; and
manipulating a shape to enhance the palm image.

7. The method according to claim 1, wherein said step of extracting a value of each line of the palm comprises:
extracting a value of the life line;
extracting a value of the heart line; and
extracting a value of the head line.

8. The method according to claim 7, wherein the extraction of a value of the life line comprises:
detecting a start point of the life line in the life line beginning area included in the hand shape frame;
moving to a pixel below the start point;
storing a position value of the white pixel and moving to a lower pixel in a downward direction when the pixel below the start point is white;
moving to a pixel on the right when the lower pixel is not white;
storing a position value of the white pixel and moving downward when the pixel on the right is white;
moving right again when the pixel on the right is not white; and
terminating the extraction of a value of the life line when no more white pixels are detected during movement over a predetermined number of pixels.

9. The method according to claim 7, wherein the extraction of a value of the life line comprises:
applying a mask to a predetermined area of the palm image to remove fine lines;
designating a pixel on the boundary of the mask facing the life line and selecting a plurality of pixels by increasing a Y coordinate of the given pixel by a predetermined number of pixels at each increase;
storing white pixels detected first by increasing X coordinates of the selected plurality of pixels;
deleting any of the stored white pixels which has a value smaller than the previous pixel or greater than the next pixel;
setting an undeleted white pixel with the greatest X coordinate as a start point;
moving to a pixel below the start point;
storing a position value of the white pixel and moving to a lower pixel in a downward direction when the pixel below the start point is white;
moving to a pixel on the right when the lower pixel is not white;
storing a position value of the white pixel and moving downward when the pixel on the right is white;
moving right again when the pixel on the right is not white;
moving to the start point when no more white pixels are detected during movement over a predetermined number of pixels;
moving to a pixel on the left from the start point;
storing a position value of the white pixel and moving left again when the pixel on the left is white;
moving to an upper pixel when the pixel on the left is not white;
storing a position value of the white pixel and moving left when the upper pixel is white;
moving upward again when the upper pixel is not white; and
terminating the extraction of a value of the life line when a position value of the hand shape frame is detected during movement.

10. The method according to claim 7, wherein the extraction of a value of the life line comprises:
applying a mask to a predetermined area of the palm image to remove fine lines;
designating a pixel on the boundary of the mask facing the life line and selecting a plurality of pixels by increasing a Y coordinate of the given pixel by a predetermined number of pixels at each increase;
storing white pixels detected first by increasing X coordinates of the selected plurality of pixels;
deleting any of the stored white pixels which has a value smaller than the previous pixel or greater than the next pixel;
setting an undeleted white pixel with the greatest X coordinate as a start point;
moving to a pixel on the left from the start point;
when the pixel on the left is white, storing a position value of the white pixel and moving left again;
moving to an upper pixel when the pixel on the left is not white;
storing a position value of the white pixel and moving left when the upper pixel is white;
moving upward again when the upper pixel is not white;
moving to the start point when a position value of the hand shape frame is detected during movement;
moving to a pixel below the start point;
storing a position value of the white pixel and moving to a lower pixel in a downward direction when the pixel below the start point is white;
moving to a pixel on the right when the lower pixel is not white;
storing a position value of the white pixel and moving downward when the pixel on the right is white;
moving right again when the pixel on the right is not white; and
terminating the extraction of a value of the life line when no more white pixels are detected during movement over a predetermined number of pixels.

11. The method according to claim 9, wherein said predetermined area applied by the mask to remove fine lines is an area below the life line.

12. The method according to claim 10, wherein said predetermined area applied by the mask to remove fine lines is an area below the life line.

13. The method according to any of claims 8, wherein said position value of each white pixel is stored in a stack.

14. The method according to any of claims 10, wherein said position value of each white pixel is stored in a stack.

15. The method according to claim 7, wherein the extraction of a value of the heart line comprises:
applying a mask to a predetermined area of the palm image to remove fine lines;
designating a pixel on the boundary of the mask facing the heart line and selecting a plurality of pixels by decreasing an X coordinate of the given pixel by a predetermined number of pixels at each decrease;
storing white pixels detected first by increasing Y coordinates of the selected plurality of pixels;
setting one of the stored white pixel which has the greatest X coordinate as a start point;
moving to a pixel on the left from the start point;
storing a position value of the white pixel and moving left again when the pixel on the left is white;
moving to an upper pixel when the pixel on the left is not white;
storing a position value of the white pixel and moving left when the upper pixel is white;
moving upward again when the upper pixel is not white; and
terminating the extraction of a value of the heart line when no more white pixels are detected during movement over a predetermined number of pixels.

16. The method according to claim 15, wherein said start point of the heart line is set within the heart line beginning area included in the hand shape frame.

17. The method according to claim 15, wherein said position value of each white pixel is stored in a stack.

18. The method according to claim 7, wherein the extraction of a value of the head line comprises:
moving to the left from the start point of the heart line until a white pixel is detected;
setting the first white pixel detected in the left direction as a start point of the head line;
moving to a pixel on the left from the start point;
storing a position value of the white pixel and moving left again when the pixel on the left is white;
moving to an upper pixel when the pixel on the left is not white;
storing a position value of the white pixel and moving left when the upper pixel is white;
moving upward again when the upper pixel is not white;
moving to the start point when a position value of the hand shape frame is detected during movement;
moving to a pixel on the right from the start point;
storing a position value of the white pixel and moving right again when the pixel on the right is white;
moving to a lower pixel in a downward direction when the pixel on the right is not white;
storing a position value of the white pixel and moving right when the lower pixel is white;
moving downward again when the lower pixel is not white; and
terminating the extraction of a value of the head line when no more white pixels are detected during movement over a predetermined number of pixels.

19. The method according to claim 18, wherein the extraction of a value of the head line comprises:
moving to a pixel on the right from the start point;
storing a position value of the white pixel and moving right again when the pixel on the right is white;
moving to a lower pixel in a downward direction when the pixel on the right is not white;
storing a position value of the white pixel and moving right when the lower pixel is white;
moving downward again when the lower pixel is not white;
moving to the start point when no more white pixels are detected during movement over a predetermined number of pixels;
moving to a pixel on the left from the start point;
storing a position value of the white pixel and moving left again when the pixel on the left is white;
moving to an upper pixel when the pixel on the left is not white;
storing a position value of the white pixel and moving left when the upper pixel is white;
moving upward again when the upper pixel is not white; and
terminating the extraction of a value of the head line when a position value of the hand shape frame is detected during movement.

20. The method according to claim 18, wherein said position value of each white pixel is stored in a stack.

21. The method according to claim 1, wherein said step of obtaining a length and a slope of each line of the palm comprises:
finding a start point, a middle point and an end point of a line through the stack storing the value of the line;
obtaining a length of the line based on the start and end points; and
obtaining a slope of the line based on the start, middle and end points.

22. The method according to claim 1, wherein said step of outputting results of palm reading comprises:
outputting results of interpretation of the life line based on the obtained length and slope of the life line;
outputting results of interpretation of the heart line based on the obtained length of the heart line; and
outputting results of interpretation of the head line based on the obtained length and slope of the head line.

23. A method for reading a palm using a mobile terminal by extracting a life line, a heart line and a head line on the palm, comprising the steps of:
displaying a hand shape frame when the mobile terminal is changed to a palm photograph mode;
photographing a palm within the hand shape frame;
changing the photographed palm image to a grayscale image;
detecting edges in the palm image;
obtaining a length and a slope of a life line of the palm;
obtaining a length of a heart line of the palm;
obtaining a length and a slope of a head line of the palm; and
outputting results of palm reading based on the obtained lengths and slopes of the lines of the palm.

24. The method according to claim 23, wherein said step of obtaining the length and slope of the life line comprises:
applying a mask to a predetermined area of the palm image to remove fine lines;
designating a pixel on the boundary of the mask facing the life line and selecting a plurality of pixels by increasing a Y coordinate of the given pixel by a predetermined number of pixels at each increase;
storing white pixels detected first by increasing X coordinates of the selected plurality of pixels;
deleting any of the stored white pixels which has a value smaller than the previous pixel or greater than the next pixel;
setting an undeleted white pixel with the greatest X coordinate as a start point;
moving to a pixel below the start point;
storing a position value of the white pixel and moving to a lower pixel in a downward direction when the pixel below the start point is white;
moving to a pixel on the right when the lower pixel is not white;
storing a position value of the white pixel and moving downward when the pixel on the right is white;
moving right again when the pixel on the right is not white;
moving to the start point when no more white pixels are detected during movement over a predetermined number of pixels;
moving to a pixel on the left from the start point;
storing a position value of the white pixel and moving left again when the pixel on the left is white;
moving to an upper pixel when the pixel on the left is not white;
storing a position value of the white pixel and moving left when the upper pixel is white;
moving upward again when the upper pixel is not white;
terminating the extraction of a value of the life line when a position value of the hand shape frame is detected during movement;
obtaining a start point, a middle point and an end point of the life line through a stack storing the value of the life line;
obtaining a length of the life line based on the start and end points; and
obtaining a slope of the life line based on the start, middle and end points.

25. The method according to claim 23, wherein said step of obtaining the length of the heart line comprises:
designating a pixel on the boundary of a mask facing the heart line and selecting a plurality of pixels by decreasing an X coordinate of the given pixel by a predetermined number of pixels at each decrease;
storing white pixels detected first by increasing Y coordinates of the selected plurality of pixels;
setting one of the stored white pixel which has the greatest X coordinate as a start point;
moving to a pixel on the left from the start point;
storing a position value of the white pixel and moving left again when the pixel on the left is white;
moving to an upper pixel when the pixel on the left is not white;
storing a position value of the white pixel and moving left when the upper pixel is white;
moving upward again when the upper pixel is not white;
terminating the extraction of a value of the heart line when no more white pixels are detected during movement over a predetermined number of pixels;
obtaining a start point and an end point of the heart line through a stack storing the value of the heart line; and
obtaining a length of the heart line based on the start and end points.

26. The method according to claim 23, wherein said step of obtaining the length and slope of the head line comprises:
moving to the left from the start point of the heart line until a white pixel is detected;
setting the first white pixel detected in the left direction as a start point of the head line;
moving to a pixel on the left from the start point;
storing a position value of the white pixel and moving left again when the pixel on the left is white;
moving to an upper pixel when the pixel on the left is not white;
storing a position value of the white pixel and moving left when the upper pixel is white;
moving upward again when the upper pixel is not white;
moving to the start point when a position value of the hand shape frame is detected during movement;
moving to a pixel on the right from the start point;
storing a position value of the white pixel and moving right again when the pixel on the right is white;
moving to a lower pixel in a downward direction when the pixel on the right is not white;
storing a position value of the white pixel and moving right when the lower pixel is white;
moving downward again when the lower pixel is not white;
terminating the extraction of a value of the head line when no more white pixels are detected during movement over a predetermined number of pixels;
obtaining a start point, a middle point and an end point of the head line through a stack storing the value of the head line;
obtaining a length of the head line based on the start and end points; and
obtaining a slope of the head line based on the start, middle and end points.

27. An apparatus for reading a user's palm using a mobile terminal by extracting a life line, a heart line and a head line from the palm, the apparatus comprises:
a camera adapted to photograph the user's palm;
a display adapted to display messages concerning the user's palm;
a memory adapted to store programs for operating the palm reading function;
a controller adapted to control the mobile terminal to photograph the user's palm when the mobile terminal is in a palm photograph mode, convert the photographed palm image to a grayscale image, detect edges in the palm image, extract a value of each line from the palm, obtain a length and a slope of each line of the palm based on the extracted value, and output results of the palm reading based on the length and slope of each line of the palm.

28. The apparatus according to claim 27, wherein a hand shape frame is displayed in said palm photograph mode.

29. The apparatus according to claim 28, wherein said hand shape frame comprises an area in which the life line, the head line begin and the heart line begin.

30. The apparatus according to claim 27, wherein the controller is further adapted to read the photographed palm image, eliminate a predetermined area of left and right sides of the read palm image, and convert the palm image excluding the eliminated area to a grayscale image.

31. The apparatus according to claim 27, wherein the controller is further adapted to enhance image contrast after the photographed palm image is converted to the grayscale.

32. The apparatus according to claim 27, wherein the controller is further adapted to remove fine lines in the palm image, binarize the palm image, and manipulate a shape to enhance the palm image.

33. The apparatus according to claim 27, wherein the controller is further adapted to extract a value of the life line, extract a value of the heart line, and extract a value of the head line.
